(19) United States
(12) Patent Application Publication
(10) Pub. No.: US 2011/0223914 A1
(43) Pub. Date: Sep. 15, 2011

(54) RADIO BASE STATION APPARATUS, RADIO COMMUNICATING METHOD IN RADIO BASE STATION APPARATUS, AND RADIO COMMUNICATION PROGRAM

(75) Inventor: Masanori Hashimoto, Kawasaki (JP)

(73) Assignee: FUJITSU LIMITED, Kawasaki-shi (JP)

(21) Appl. No.: 13/015,799

(22) Filed: Jan. 28, 2011

(30) Foreign Application Priority Data
Mar. 12, 2010 (JP) 2010-56039

(51) Int. Cl. H04W 36/00

(52) U.S. Cl. 455/436

(57) ABSTRACT

A radio base station apparatus for performing radio communication with a terminal apparatus, including: a logging processing unit which stores history information relating to handover in a storage unit, when the terminal apparatus performs handover; a change determination unit which determines whether a measurement parameter used by the terminal apparatus for determination of the handover is to be changed or not, on the basis of the history information, and outputs a change instruction if the change determination unit determines that the measurement parameter is to be changed; and a transmission unit which transmits the measurement parameter changed on the basis of the change instruction to the terminal apparatus.

### CROSS-REFERENCE TO RELATED APPLICATIONS

This application is based upon and claims the benefit of priority of the prior Japanese Patent Application No. 2010-056039, filed on Mar. 12, 2010, the entire contents of which are incorporated herein by reference.

### FIELD

The present invention relates to a radio base station apparatus, a radio communicating method in a radio base station apparatus, and a radio communication program.

### BACKGROUND

In a radio communication system, there is a technology called handover. The handover is a technology to ensure that communication of a terminal apparatus while moving is not disconnected, for example.

If the terminal apparatus finds another cell with the best communication quality when the apparatus is located in a cell (a communicable range with a base station apparatus, for example), the apparatus requests a network containing the base station apparatus or the like to perform handover to another cell. The network permits the handover in response to the request, and the terminal apparatus performs the handover on the basis of the permission.

However, if the terminal apparatus is located close to a cell boundary, for example, the apparatus might perform handover several times in a time shorter than a threshold value. Such handover gives a power load to the terminal apparatus. Also, a load is given in relation to the handover processing to each apparatus in the network.

Thus, a prior-art technology is known that the terminal apparatus or the like makes determination on handover using a hysteresis value (or an offset value). For example, the terminal apparatus measures a communication quality for a cell in connection, adds the hysteresis value to the measurement result, and compares this result with a measurement result of the communication quality with another cell. Since the hysteresis value was added to the measurement result of the cell in connection, as compared with a value not added with the hysteresis value, it is less likely that the added value exceeds the measurement result of the communication quality with another cell, and the number of handover sessions is reduced.

### Citation List

### Non-Patent Documents

Non-Patent Document 1: 3GPP TS 36.331 5.5 Measurements

Non-Patent Document 2: 3GPP TS 25.331 8.4 Measurement Procedure

Non-Patent Document 3: 3GPP TS 36.000

However, even if the terminal apparatus makes determination on handover using the hysterisis value, the handover might be performed several times in a time shorter than the threshold value depending on the size of the hysterisis value.

FIGS. 35A and 35B are diagrams illustrating a relationship example between a movement change of a terminal apparatus and a cell range. In FIGS. 35A and 35B, arrows indicate the movement change of the terminal apparatus.

As illustrated in FIG. 35A, the cell range of a cell #2 is a range indicated by a solid line, for example, when the hysteresis value is smaller than the threshold value and is a range indicated by a dotted line, for example, when the hysteresis value is larger than the threshold value. If the hysteresis value smaller than the threshold value is used, the terminal apparatus performs handover at a position indicated by a circular mark. On the other hand, if the hysteresis value larger than the threshold value is used, the terminal apparatus moves in the cell range of the cell #2 and does not perform handover. In the example in FIG. 35A, if the cell range is widened, the number of handover sessions is reduced from “2” to “0”.

On the other hand, in the case of the example in FIG. 35B, the cell range of a cell #1 is a range indicated by a solid line similarly to the example in FIG. 35A, if the hysteresis value smaller than the threshold value is used. In this case, if the terminal apparatus performs handover from the cell #1 to a cell #3, the cell range of the cell #3 is moved, and the handover is not performed. However, if the hysteresis value larger than the threshold value is used, the cell range of the cell #1 becomes as indicated by a dotted line, and the terminal apparatus performs handover from the cell #1 to the cell #2 and moreover, from the cell #2 to the cell #3. In the case of this example, if the cell range is widened, the number of handover sessions is increased from “1” to “3”.

As described above, even if the hysteresis value is made larger than the threshold value (even if the cell range is widened), the number of handover sessions is not necessarily reduced from a predetermined number. Depending on a geological condition in the vicinity of the cell boundary, the number of handover sessions with the hysteresis value smaller than the threshold value might be reduced rather than the hysteresis value larger than the threshold value. Occurrence of such handover is not grasped until the radio base station apparatus and the terminal apparatus are actually operated in many cases.

And in relation to adjustment of the hysteresis value as above, to have an operator who operates the radio base station make manual adjustment during actual operation costs the operator a burden.

### SUMMARY

According to an aspect of the invention, a radio base station apparatus for performing radio communication with a terminal apparatus, including: a logging processing unit which stores history information relating to handover in a storage unit, when the terminal apparatus performs handover; a change determination unit which determines whether a measurement parameter used by the terminal apparatus for determination of the handover is to be changed or not, on the basis of the history information, and outputs a change instruction if the change determination unit determines that the measurement parameter is to be changed; and a transmission unit which transmits the measurement parameter changed on the basis of the change instruction to the terminal apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a radio communication system.

FIG. 2 is a diagram illustrating a configuration example of a network.

FIGS. 3A and 3B are diagrams illustrating a relationship example between a cell and a radio base station apparatus.

FIGS. 4A to 4C are diagrams illustrating a relationship example between the cell and the radio base station apparatus.

FIGS. 5A and 5B are diagrams illustrating a relationship example between the cell and the radio base station apparatus.

FIG. 6 is a diagram illustrating a configuration example of the radio base station apparatus.

FIG. 7 is a diagram illustrating a configuration example of a control unit of the radio base station apparatus.

FIG. 8 is a diagram illustrating a configuration example of a terminal apparatus.

FIG. 9 is a diagram illustrating a configuration example of a digital baseband processing control unit of the terminal apparatus.

FIG. 10 is a sequence chart illustrating an operation example.

FIGS. 11A and 11B are diagrams illustrating a configuration example of a table.

FIG. 12 is a diagram illustrating a relationship example between a moving history of the terminal apparatus and the cell.

FIG. 13 is a sequence chart illustrating the operation example.

FIG. 14 is a sequence chart illustrating the operation example.

FIG. 15 is a sequence chart illustrating the operation example.

FIGS. 16A and 16B are diagrams illustrating a configuration example of the table.

FIG. 17 is a diagram illustrating a relationship example between a moving history of the terminal apparatus and the cell.

FIG. 18 is a sequence chart illustrating the operation example.

FIGS. 19A and 19B are diagrams illustrating the configuration example of a table.

FIG. 20 is a diagram illustrating a relationship example between a moving history of the terminal apparatus and the cell.

FIG. 21 is a sequence chart illustrating the operation example.

FIGS. 22A and 22B are diagrams illustrating the configuration example of the table.

FIG. 23 is a diagram illustrating a relationship example between a moving history of the terminal apparatus and the cell.

FIG. 24 is a sequence chart illustrating the operation example.

FIGS. 25A and 25B are diagrams illustrating the configuration example of the table.

FIG. 26 is a diagram illustrating a relationship example between a moving history of the terminal apparatus and the cell.

FIG. 27 is a sequence chart illustrating the operation example.

FIGS. 28A to 28C are diagrams illustrating the configuration example of the table.

FIG. 29 is a diagram illustrating a relationship example between a moving history of the terminal apparatus and the cell.

FIG. 30 is a diagram illustrating another configuration example of the control unit in the radio base station apparatus.

FIGS. 31A to 31D are diagrams illustrating an example of information stored in HSS.

FIG. 32 is a sequence diagram illustrating an operation example.

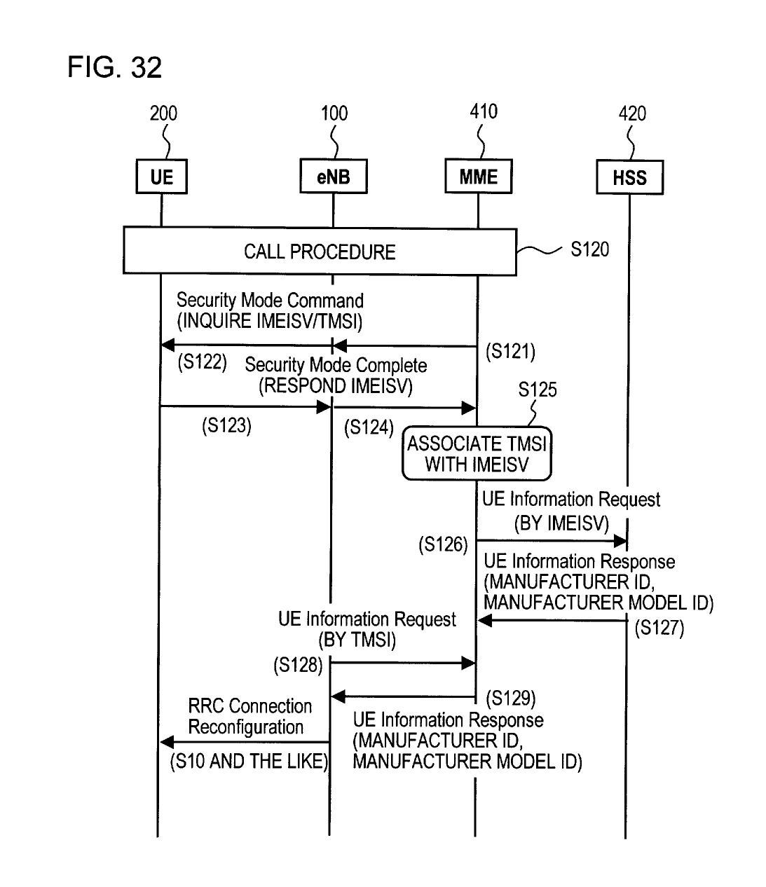

FIGS. 33A to 33C are diagrams illustrating a configuration example of the table.

FIG. 34A is a diagram illustrating a control unit of the radio base station apparatus, and FIG. 34B is a diagram illustrating each configuration example of the control unit in the terminal apparatus.

FIGS. 35A and 35B are diagrams illustrating relationship examples between a moving history of the terminal apparatus and the cell.

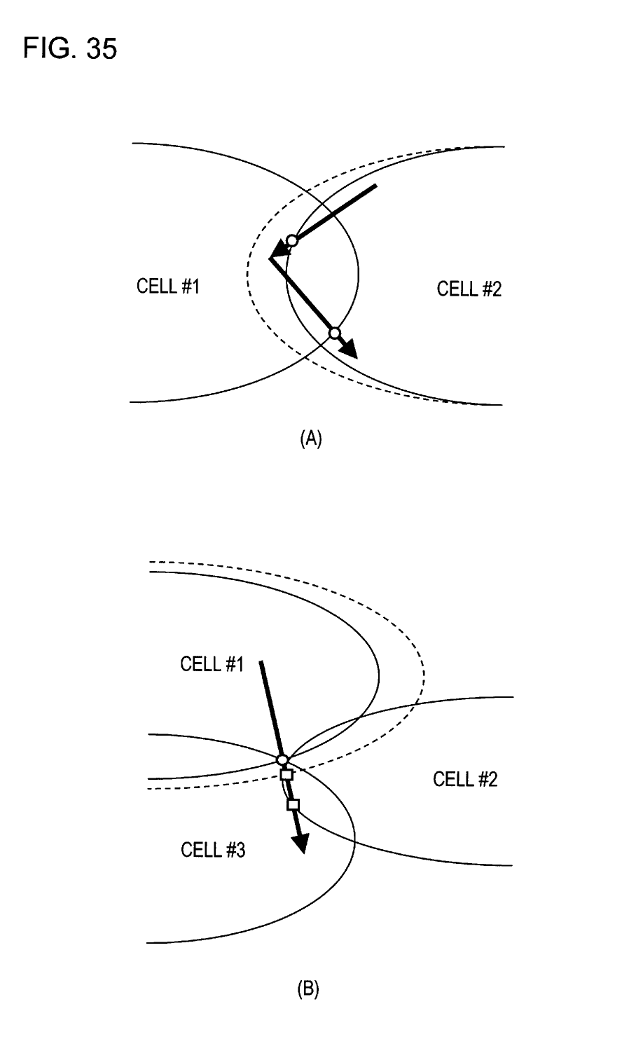

### DESCRIPTION OF EMBODIMENTS

Embodiments for carrying out the present invention will be described below.

### First Embodiment

First, a first embodiment will be described. A configuration example of this system, a relationship between a cell and a radio base station apparatus, configuration examples of the radio base station apparatus and a terminal apparatus and operations will be described below in order.

<Configuration Example of System>

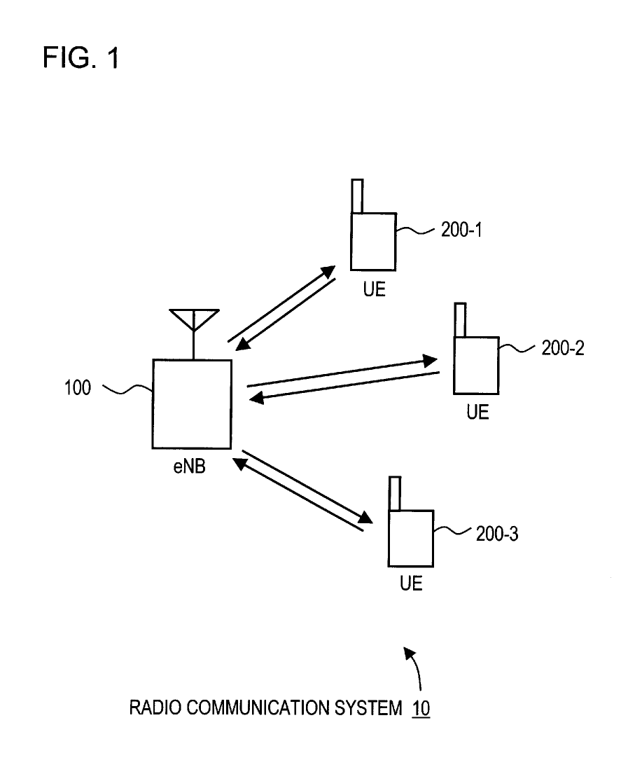

First, a configuration example of a radio communication system will be described. FIG. 1 is a diagram illustrating the configuration example of a radio communication system 10.

The radio communication system 10 includes a radio base station apparatus (eNodeB, hereinafter referred to as “base station”) 100 and terminal apparatuses (User Equipment, hereinafter referred to as “terminal”) 200-1 to 200-3. The terminals 200-1 to 200-3 can perform radio communication with the base station 100 when they are located within a cell range of the base station 100. The number of terminals 200-1 to 200-3 capable of communication with the base station 100 may be 1 or plural.

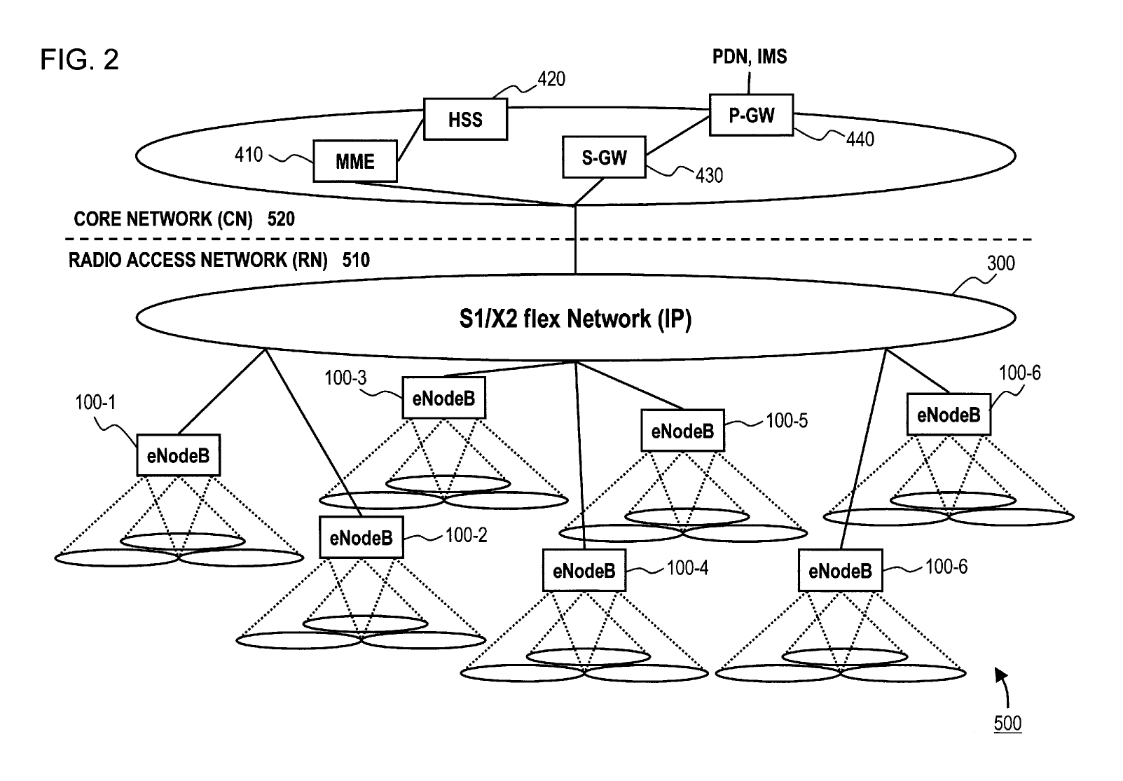

FIG. 2 is a diagram illustrating a diagram example of a network 500 including the base station 100. This network 500 includes a radio access network (Radio Network) 510 and a core network (Core Network) 520.

The radio access network 510 includes a S1/X2 Flex Network (or IP Network, hereinafter referred to as “IP network”) 300 and a plurality of base stations 100-1 to 100-6 connected to the IP network 300.

Each of the base stations 100-1 to 100-6 can send or receive a message or the like to or from another of the base stations 100-1 to 100-6 via the IP network 300 using the X2 interface, for example. Also, each of the base stations 100-1 to 100-6 can send or receive a message or the like to or from each device 430, . . . in the core network 520 via the IP network 300 using the S1 interface, for example.

The IP network 300 is a network that connects each of the base stations 100-1 to 100-6 to the core network 520.

On the other hand, the core network 520 includes an MME (Mobility Management Entity) 410, an HSS (Home Subscriber Server) 420, an S-GW (Serving Gateway) 430, and a P-GW (Packet Data Network Gateway) 440.

The MME 410 is connected to the IP network 300 and executes access control of the terminal 200, a paging procedure for the terminal 200, user authentication and the like.

The HSS 420 is connected to the MME 410 and manages number information of subscribers, type information of a mobile station, subscriber information such as roaming information and the like.

The S-GW 430 is connected to the IP network 300 and switches user data and transmits the user data to the P-GW 440 or each of the base stations 100-1 to 100-3, for example.

The P-GW 440 is connected to the S-GW 430, a packet network (PDN) and the like and performs allocation of an IP address to the terminal 200 and the like and also plays a role of an interface to the user data with another network such as the PDN.

The radio communication system 10 in FIG. 1 is also a part of the radio access network 510 illustrated in FIG. 2, for example.

<Relationship Between Cell and Base Station>

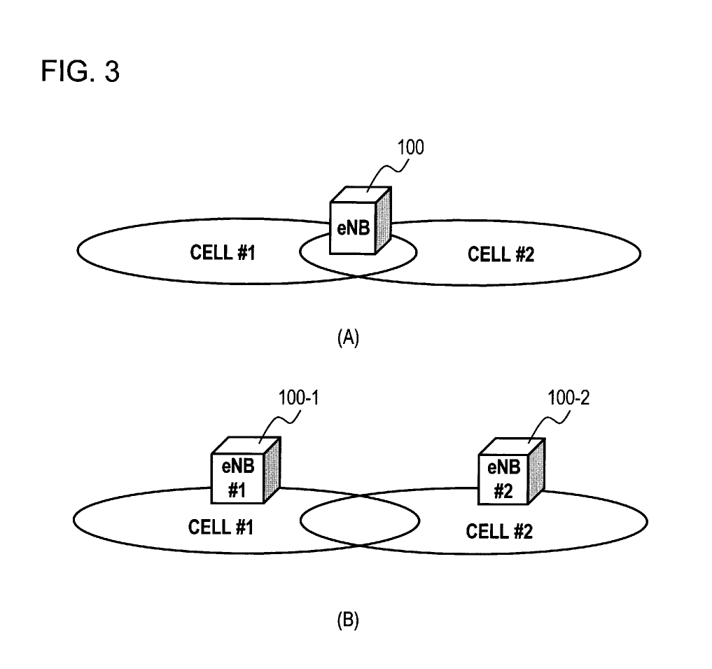

An operation of handover, which will be described later, might be different depending on the relationship between the base station 100 and a cell. Thus, the relationship between the base station 100 and the cell will be described below. FIGS. 3A to 5B are diagrams illustrating relationship examples between the base station 100 and the cell. The cell is a unit by which the terminal 200 performs handover, for example, and is also a wave reaching range for each antenna of the base station 100.

FIGS. 3A and 3B are diagrams illustrating the relationship examples between two cells and the base station. In this case, the terminal 200 performs handover by moving between two cells #1 and #2. When the terminal 200 performs handover between the two cells, such handover is referred to as “across-two-cells” as appropriate.

FIG. 3A is an example of a case in which one base station 100 contains two cells in the “across-two-cells”, while FIG. 3B illustrates an example in which the two different base stations 100-1 and 100-2 contain the cells #1 and #2, respectively, in the “across-two-cells”.

When the terminal 200 moves as “cell #1-> cell #2-> cell #1” in a time shorter than a threshold value in the “across-two-cells” manner, this base station 100 operates so that such handover is not performed.

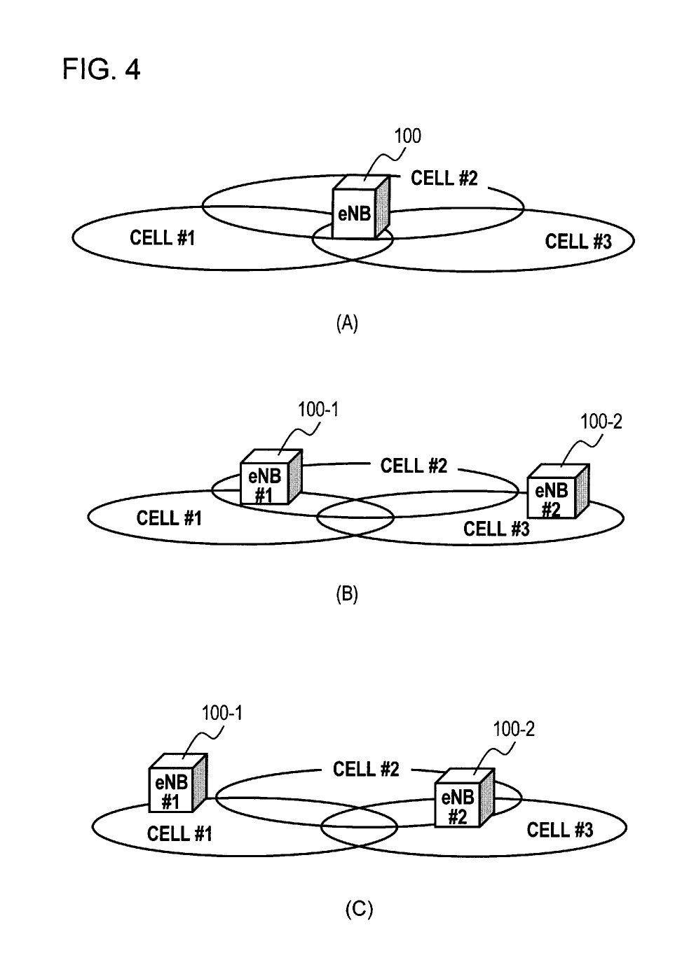

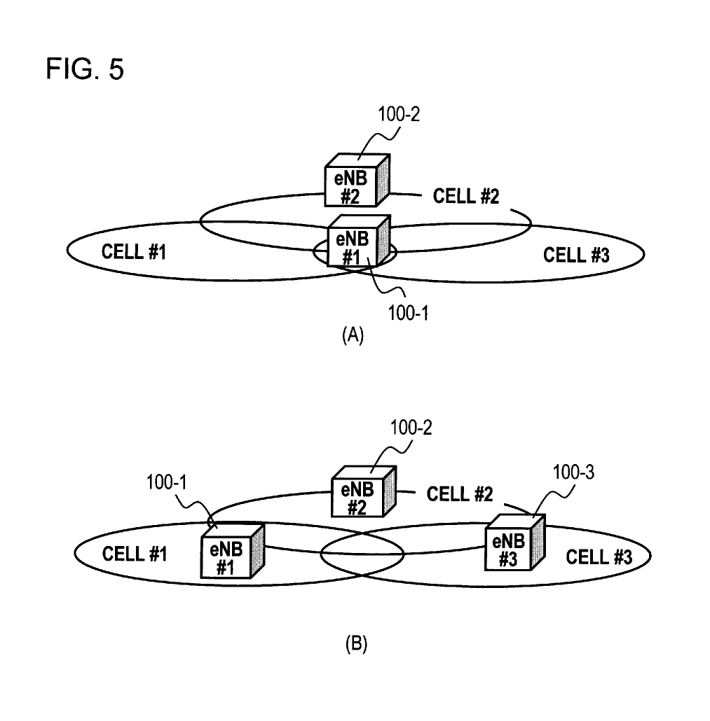

FIGS. 4A to 5B similarly illustrate the relationship examples between the base station 100 and the cell but illustrates a relationship example when the terminal 200 moves among the three cells (hereinafter referred to as “across-three-cells” as appropriate).

FIG. 4A is an example in which one base station 100 contains the three cells (cells #1 to #3), and FIG. 4B is an example in which the base station 100-1 contains the cell #1 and the cell #2, and the base station 100-2 contains the cell #3. Also, FIG. 4C is an example in which the base station 100-1 contains the cell #1, and the base station 100-2 contains the cell #2 and the cell #3, respectively. Moreover, FIG. 5A is an example in which the base station 100-1 contains the cell #1 and the cell #3, and the base station 100-2 contains the cell #2, respectively, and FIG. 5B is an example in which each of the base stations 100-1 to 100-3 contains the cells #1 to #3, respectively.

In the case of the “across-three-cells” or if the terminal 200 moves as “cell #1-> cell #2-> cell #3” in a time shorter than the threshold value, for example, this base station 100 prevents occurrence of such handover and operates the terminal 200 so as that “cell #1-> cell #3” is obtained. The operation will be described later.

<Configuration Example of Base Station and Terminal>

Subsequently, configuration examples of the base station 100 and the terminal 200 will be described.

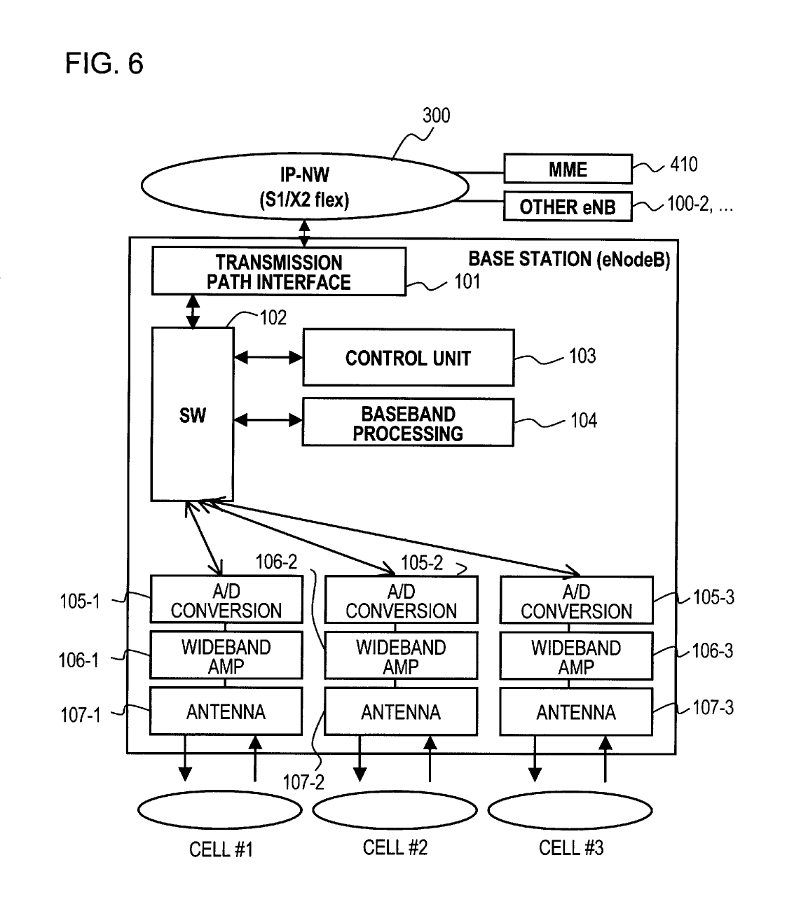

FIG. 6 is a diagram illustrating a configuration example of the base station 100. The base station 100 includes a transmission path interface 101, a switch (hereinafter referred to as “SW”) 102, a control unit 103, a baseband processing unit 104, A/D conversion units 105-1 to 105-3, wideband amplifiers 106-1 to 106-3, and antennas 107-1 to 107-3.

The transmission path interface 101 is connected to the SW 102 and the IP network 300, receives a message or the like transmitted from the IP network 300, converts it to a format that can be processed in the base station 100, for example, and outputs it to the SW 102. Also, the transmission path interface 101 coverts the message or the like outputted from the SW 102 to a format that can be transmitted to the IP network 300 and outputs it to the IP network 300.

The SW 102 outputs the message or the like outputted from the transmission path interface 101 to the control unit 103 or the baseband processing unit 104. Also, the SW 102 outputs the message or the like outputted from the control unit 103 or the baseband processing unit 104 to the A/D conversion units 105-1 to 105-3 or the transmission path interface 101. Moreover, the SW 102 outputs data or message or the like outputted from each of the A/D conversion units 105-1 to 105-3 to the baseband processing unit 104 or the control unit 103.

The control unit 103 controls handover and keeps logging information when the handover is performed and determines on changes of a measurement parameter used for the handover and the like on the basis of the logging information. Details of the control unit 103 will be described later.

The baseband processing unit 104 executes various processing to a baseband signal such as MAC multiple separation or the like, synchronization processing, paging processing and processing such as traffic monitoring or the like.

The A/D conversion units 105-1 to 105-3 convert the data or message and the like outputted from the SW 102 to an analog signal and convert the data and the like outputted from each of the wideband amplifiers 106-1 to 106-3 to a digital signal.

The wideband amplifiers 106-1 to 106-3 amplify the data and the like outputted from the A/D conversion units 105-1 to 105-3, respectively, and output it to each of the antennas 107-1 to 107-3. Also, the wideband amplifiers 106-1 to 106-3 output the data and the like outputted from each of antennas 107-1 to 107-3 to the A/D conversion units 105-1 to 105-3, respectively.

The antennas 107-1 to 107-3 receive the data and the like transmitted from the terminal 200 within the cell range and output it to the wideband amplifiers 106-1 to 106-3, respectively, and transmit the data and the like outputted from the wideband amplifiers 106-1 to 106-3, respectively, to the terminal 200 within the cell range.

The configuration example of the base station 100 illustrated in FIG. 6 is an example of the base station 100 containing the three cells, and thus, the A/D conversion units 105-1 to 105-3, the wideband amplifiers 106-1 to 106-3, and the antennas 107-1 to 107-3 are disposed in three each. If the base station 100 contains two cells, the two A/D conversion units 105-1 and 105-2, the two wideband amplifiers 106-1 and 106-2, and the two antennas 107-1 and 107-2 may be disposed. The number of the respective units 105-1, . . . is adjusted in accordance with the number of cells. The number of the baseband processing units 104 may be also adjusted in accordance with the number of cells, but the example in FIG. 6 illustrates one baseband processing unit 104.

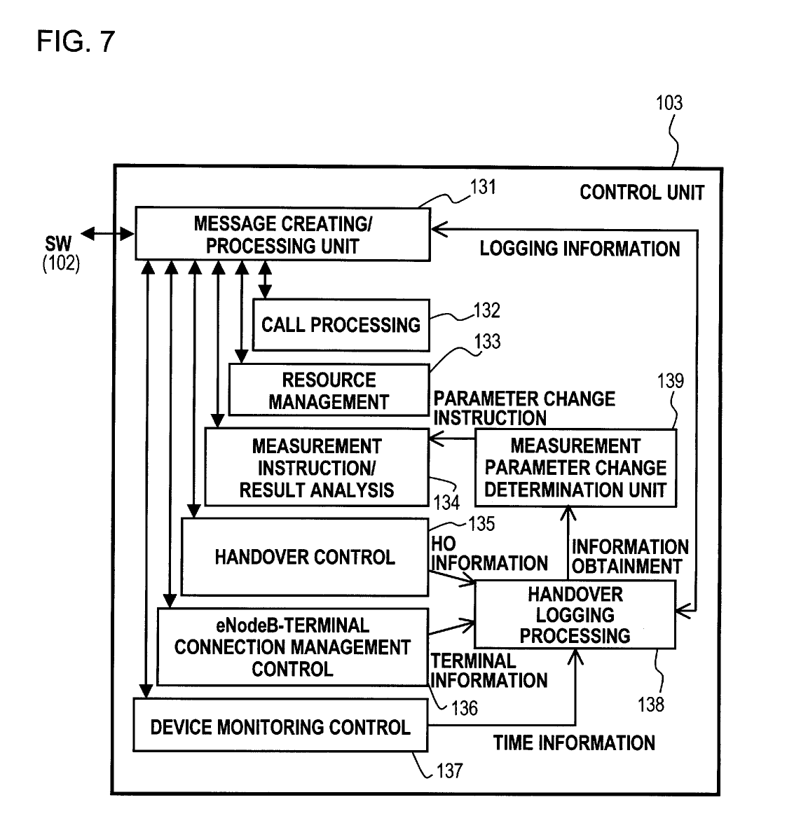

FIG. 7 is a diagram illustrating a configuration example of the control unit 103. The control unit 103 includes a message creating and processing unit (hereinafter referred to as “message creating unit”) 131, a call processing unit 132, a resource management unit 133, a measurement instruction and result analysis unit (hereinafter referred to as “measurement instruction unit”) 134, a handover control unit 135, an eNodeB-terminal connection management control unit (hereinafter referred to as “connection management control unit”) 136, a device monitoring control unit 137, a handover logging processing unit (hereinafter referred to as “logging processing unit”) 138, and a measurement parameter change determination unit (hereinafter referred to as “change determination unit”) 139.

The message creating unit 131 creates a message in accordance with a request from each of the units from the call processing unit 132 to the device monitoring control unit 137 and outputs it to a SW 102. Also, the message creating unit 131 receives an input of the message outputted from the SW 102 and outputs it to any corresponding one from the call processing unit 132 to the device monitoring control unit 137.

The call processing unit 132 performs creation of various messages for call processing and the like when a calling procedure is executed with a terminal 200.

The resource management unit 133 manages resources used for communication with the terminal 200 and stores information on a range of the resources in use, for example.

The measurement instruction unit 134 instructs creation of a message including a measurement parameter to be a reference when the terminal 200 requests handover or a hysteresis value used when the terminal 200 measures a communication quality (or an offset value), for example, to the message creating unit 131. At this time, when a parameter change instruction is inputted from the change determination unit 139, the measurement instruction unit 134 changes a measurement parameter and instructs creation of a message including the changed parameter and the like. Also, the measurement instruction unit 134 inputs a message or the like transmitted from the terminal 200 from the message creating unit 131 and executes processing such as extraction of a quality measurement value contained in the message or the like.

The handover control unit 135 instructs creation of a message and the like transmitted/received to/from the terminal 200 or another base station 100 to the message creating unit 131 when handover is executed. Also, the handover control unit 135 inputs a handover request message or the like transmitted from the terminal 200 from the message creating unit 131 and outputs handover information relating to a cell of handover destination or handover source contained in the message to the logging processing unit 138.

The connection management control unit 136 manages a state of connection with the terminal 200 such as what message or the like is to be transmitted/received during the communication connection between the base station 100 and the terminal 200. Also, the connection management control unit 136 inputs terminal information relating to a terminal identifier transmitted from the terminal 200 from the message creating unit 131 at the call processing prior to the handover, for example, and outputs the terminal information to the logging processing unit 138.

The device monitoring control unit 137 monitors a power state and the like of each unit 103 and the like in the base station 100 apparatus. Also, the device monitoring control unit 137 monitors creation time of the message created in the message creating unit 131, time when a message and the like are inputted into the message creating unit 131 or time of output and the like. The device monitoring control unit 137 outputs time when a handover request message to the base station 100 at the handover destination is outputted from the message creating unit 131 as the time information to the logging processing unit 138, for example. Also, the device monitoring control unit 137 outputs time when the handover request message transmitted from another base station is inputted into the message creating unit 131 as time information to the logging processing unit 138, for example.

The logging processing unit 138 creates logging information indicating how the handover is carried out on the basis of the handover information, terminal information, and time information and holds it in a table. The table is held in memory in the logging processing unit 138, for example. An example of the table will be described later.

The change determination unit 139 reads logging information from a table 1381 and determines if the measurement parameter is to be changed or not on the basis of the information. The change determination unit 139 determines that the measurement parameter is to be changed if in a predetermined period, the number of handover sessions such as “cell #1-> cell #2-> cell #1” in a time shorter than a threshold value is not less than a given value. If the change determination unit 139 determines that the measurement parameter is to be changed, the unit outputs an instruction to change the measurement parameter to the measurement instruction unit 134. In this case, the change determination unit 139 may instruct what hysteresis value itself is to be employed or may instruct an adjustment value to the hysteresis value, which is left as it is. Details will be described later.

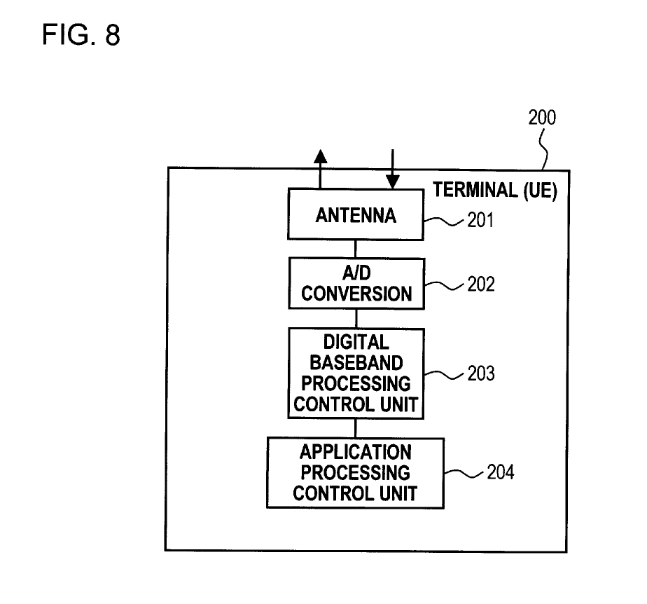

Subsequently, a configuration example of the terminal 200 will be described. FIG. 8 is a diagram illustrating a configuration example of the terminal 200. The terminal 200 includes an antenna 201, an A/D conversion unit 202, a digital baseband processing control unit (hereinafter referred to as “baseband processing control unit”) 203, and an application processing control unit 204.

The antenna 201 receives data or message and the like transmitted from the base station 100 in a cell range via radio and outputs it to the A/D conversion unit 202 and transmits data and the like outputted from the A/D conversion unit 202 to the base station 100 via radio.

The A/D conversion unit 202 converts the data and the like outputted from the antenna 201 to a digital signal and outputs it to the baseband processing control unit 203 and converts the data and the like outputted from the baseband processing control unit 203 to an analog signal and outputs it to the antenna 201.

The baseband processing control unit 203 executes creation processing of a message and the like, processing to data and the like. Details will be described later.

The application processing control unit 204 executes various application processing such that data and the like outputted from the baseband processing control unit 203 is displayed on a camera unit, outputted to a sound source unit and the like. Also, the application processing control unit 204 outputs sound and the like obtained from a microphone unit as data to the baseband processing control unit 203.

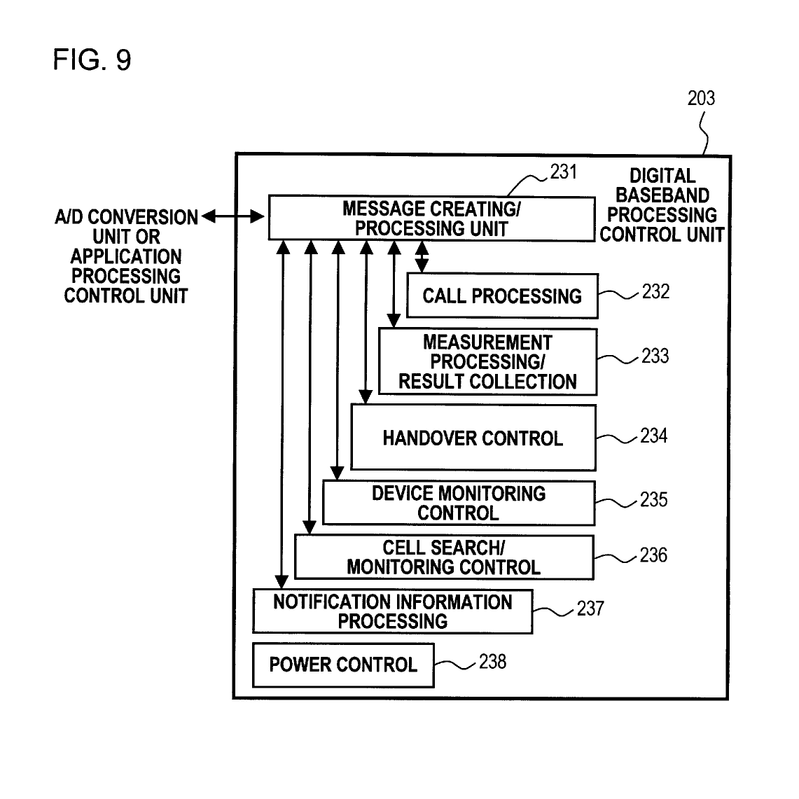

FIG. 9 is a diagram illustrating a configuration example of the baseband processing control unit 203. The baseband processing control unit 203 includes a message creating and processing unit (hereinafter referred to as “message creating unit”) 231, a call processing unit 232, a measurement processing and result collecting unit (hereinafter referred to as “measurement processing unit”) 233, a handover control unit 234, a device monitoring control unit 235, a cell search/monitoring control unit (hereinafter referred to as “cell search unit”) 236, a notification information processing unit 237, and a power control unit 238.

The message creating unit 231 creates a message and the like in accordance with a request from each of the units from the call processing unit 232 to the notification information processing unit 237 and outputs it to the A/D conversion unit 202 or the application processing control unit 204. Also, the message creating unit 231 receives an input of the message and the like outputted from the A/D conversion unit 202 or the application processing control unit 204 and outputs it to any one from the call processing unit 232 to the notification information processing unit 237.

The call processing unit 232 requests creation of a message from the message creating unit 231 in order to execute a call procedure with the terminal 200 or the MME 410. Also, the call processing unit 232 inputs a message or the like outputted from the terminal 200 or the MME 410 from the message creating unit 231 and executes processing for the call procedure or the like.

The measurement processing unit 233 makes measurement or the like of a communication quality for each cell. For example, the measurement processing unit 233 measures reception power to a known signal transmitted from the base stations 100-1, . . . or a power ratio of a desired signal to an interference signal (SIR, SINR and the like). For example, the call processing 232 or the measurement processing unit 233 holds a terminal identifier transmitted from the MME 420 through the base station 100.

The handover control unit 234 requests the message creating unit 231 to create a message to be transmitted at the handover processing. Also, the handover control unit 234 receives an input of a message and the like received from the base station 100 and the like from the message creating unit 231 and executes various processing to the handover.

The device monitoring control unit 235 monitors whether each unit 231, . . . in the terminal 200 is normally operating or not.

The cell search unit 236 makes a cell search or a search of a cell with the smallest path loss when the terminal 200 is powered on, for example. For example, the cell search unit 236 can make a sell search in multiple stages.

The notification information processing unit 237 executes various processing to the notification information received from the base station 100 at the connection destination. The notification information processing unit 237 outputs adjacent cell information (identifier of each cell or identifier of each base station 100) contained in the notification information to the measurement processing unit 233, for example.

The power control unit 238 controls power of each unit in the terminal 200.

<Operation>

Subsequently, an operation will be described. The operation will be described separately for the case of “across-two-cells” (FIG. 3A and FIG. 3B) and the case of “across-three-cells” (FIGS. 4A to 5B).

<Operation in the Case of “Across-Two-Cells”>

The operation in the case of the “across-two-cells” includes a case of the operation in one base station 100 (FIG. 3A) and a case of the operation between two base stations 100 (FIG. 3B). These two cases will be described separately.

<1.1 When “Across-Two-Cells” is Performed by One Base Station 100>

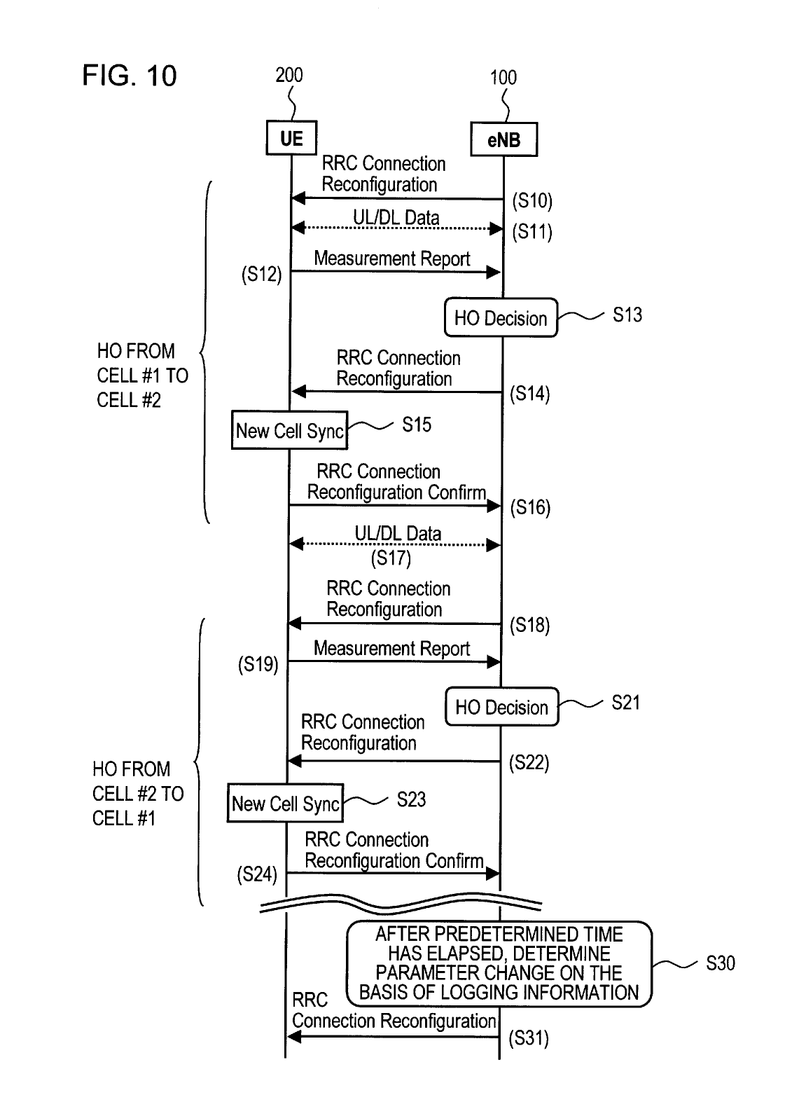

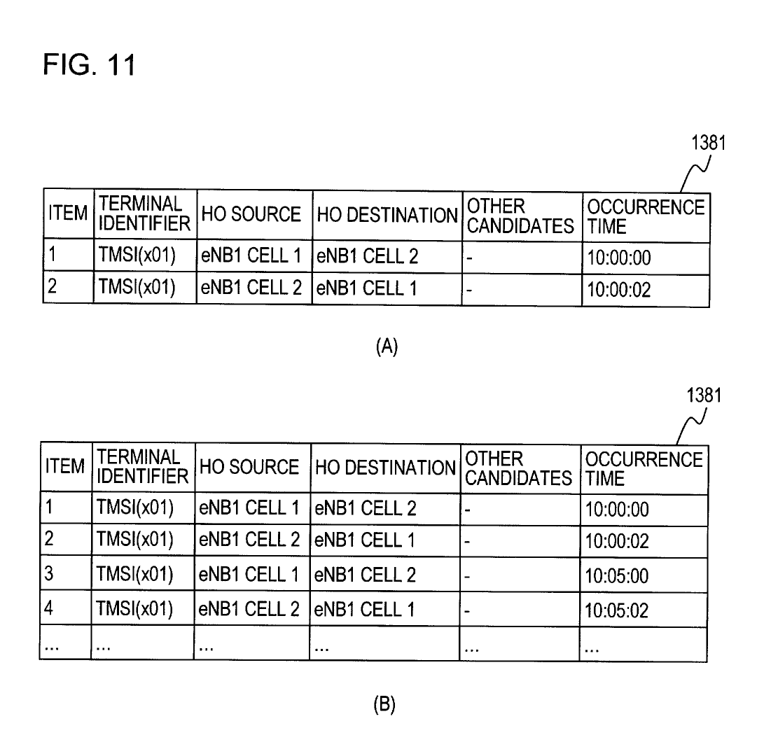

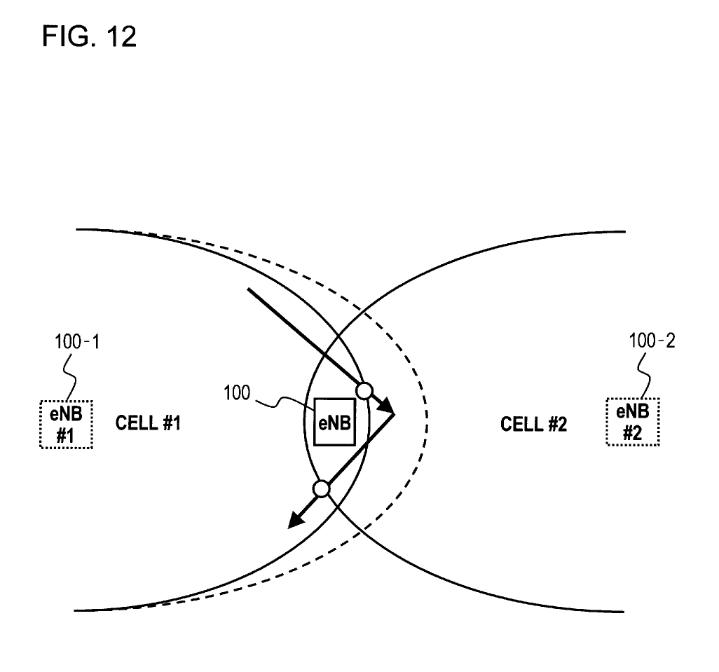

FIG. 10 is a sequence diagram illustrating an operation example when the “across-two-cells” is performed by one base station 100, FIG. 11A and FIG. 11B illustrate examples of the table 1381 in that case, and FIG. 12 illustrates a relationship example between the cell and the movement change of the terminal 200, respectively. In this example, the terminal 200 moves from the cell #1 to the cell #2 of one base station 100, and this is an example in which the terminal moves from the cell #2 to the cell #1 in a time shorter than a threshold time.

The terminal 200 is located in the cell #1, the call processing is executed between the terminal 200 and the base station 100 as well as the MME 420 prior to this operation, and the base station 100 is supposed to hold a terminal identifier of the terminal 200 (such as TMSI (Temporary Mobile Subscriber Identity), for example). Also, the terminal 200 receives the notification information from the base station 100 and is supposed to hold the identifier of each cell (or cell ID).

The base station 100 transmits an RRC Connection Reconfiguration message (hereinafter referred to as “Reconfiguration message”) to the terminal 200 (S10) as illustrated in FIG. 10. This Reconfiguration message includes a measurement parameter (such as hysteresis value) when the terminal 200 performs handover. For example, when the measurement instruction unit 134 requests the message creating unit 131 to create the message, the message is transmitted to the terminal 200 through the SW 102 and the like. For example, the measurement instruction unit 134 may request creation of the message regularly.

Then, if data is transmitted or received between the base station 100 and the terminal 200, the data is transmitted or received (S11).

Then, the terminal 200 transmits a Measurement Report message. This message is also a request message of handover from the cell #1 to the cell #2, and the measurement processing unit 233 requests the message creating unit 231 to create the message so that the identifier of the cell #2, the quality measurement value of the cell #2, and the terminal identifier of itself are included. For example, the measurement processing unit 233 adds the hysteresis value included in the Reconfiguration message to the reception quality measurement value of the cell #1 and compares the added value and the reception quality measurement value of the cell #2. Then, if the reception quality measurement value of the cell #2 is better than the added value, the measurement processing unit 233 requests the message creating unit 231 to create the Measurement Report message including the identifier of the cell #2 and the like.

When the base station 100 receives the message, it determines execution of the handover (S13). For example, the handover control unit 135 determines execution of the handover of the terminal 200 from the cell #1 to the cell #2 if the Measurement Report message is inputted from the message creating unit 231.

Then, the base station 100 transmits the Reconfiguration message to the terminal 200 (S14) in order to instruct execution of handover (or to allow execution of handover). For example, when the handover control unit 135 requests the message creating unit 131 to create the message including an execution instruction of handover after determination of the execution of handover, the message is transmitted to the terminal 200.

When the terminal 200 receives the Reconfiguration message, it executes processing to establish synchronization with the cell #2 and the like (S15). For example, the handover control unit 234 executes the processing to establish synchronization.

After synchronization with the cell #2 is established, the terminal 200 transmits an RRC Connection Reconfiguration Confirm message indicating that the handover to the cell #2 is completed (hereinafter referred to as “Confirm message”) to the base station 100 (S16). For example, after the handover control unit 234 finished the synchronization establishment processing and the like, by requesting the message creating unit 231 to create the Confirm message, the message is transmitted to the base station 100. Also, the handover control unit 135 of the base station 100 confirms that the handover is completed by inputting the message from the message creating unit 131. As a result, the terminal 200 completes the handover from the cell #1 to the cell #2.

Then, the terminal 200 transmits or receives data with the base station 100 containing the cell #2 at the handover destination (S17).

Then, the base station 100 transmits the Reconfiguration message including various parameters to be the standard of the handover to the terminal 200 (S18). The message includes the measurement parameter used for determination of the handover similarly to S10 and includes a hysteresis value to the cell #2, for example.

Then, if the quality measurement value of the cell #1 is better than the added value obtained by adding the hysteresis value notified (S18) in the Configuration message to the quality measurement value of the cell #2, the terminal 200 transmits a Measurement Report message (S19). The message includes the identifier of the cell #1, the quality measurement value of the cell #1, the terminal identifier of the terminal 200 and the like.

When the base station 100 receives the Measurement Report message, similarly to S13, it determines execution of handover (S21). In this case, the handover control unit 135 allows execution of hand over to the cell #1, for example.

Then, similarly to S14, the base station 100 transmits the Reconfiguration message to the terminal 200 (S22) in order to instruct execution of handover. In this case, the handover control unit 135 instructs the terminal 200 to execute handover to the cell #1, for example.

Then, the terminal 200 executes processing to establish synchronization to the cell #1 at the handover destination (S23) and after the handover is completed, transmits the Confirm message to the base station 100 (S24).

As described above, the terminal 200 executes handover from the cell #1 to the cell #2 (S10 to S16) and further executes handover from the cell #2 to the cell #1 (S18 to S24).

After a predetermined time elapsed, the base station 100 determines a change of a parameter on the basis of the logging information (S30). The logging processing unit 138 holds the logging information indicating the history of each terminal 200 that executed handover within a predetermined time as the table 1381.

The table 1381 includes fields of, as illustrated in FIGS. 11A and 11B, “item”, “terminal identifier”, “HO source”, “HO destination”, “other candidates”, and “occurrence time”.

The “terminal identifier” stores an identifier that identifies the terminal 200 and stores TMSI that indicates an identification number of each terminal allocated by the MME 420 when the position of the terminal 200 is registered, for example. The identifier stored in the “terminal identifier” may be IMSI (International Mobile Subscriber Identity) indicating a terminal specific number such as a telephone number or may be IMEI (International Mobile Equipment Identity) unique to each device allocated to the terminal main body, for example.

The “HO source” is an identifier of a cell, in which the terminal 200 is the handover source, and “HO destination” is a field in which the identifier of the cell at the handover destination is stored, respectively.

The “other candidates” field stores the identifier of the cell if there are more cells to be connected at the handover other than the “HO destination”.

The “occurrence time” is a field that stores time when the handover occurs.

In the logging information, the “terminal identifier” is stored in the table 1381 when the base station 100 obtains the terminal identifier from the MME 410 or the terminal 200 by the call processing or the like, for example. For example, the connection management control unit 136 inputs the terminal identifier through the message creating unit 131 and the like in the call processing or the like and outputs it to the logging processing unit 138 so that the “terminal identifier” is stored.

Also, the “HO source” and the “HO destination” are stored by outputting the identifier of each cell at the handover source and the destination to the logging processing unit 138 when the handover control unit 135 determines execution of the handover (S13 or S21). Alternatively, the handover control unit 135 may store the identifier of each cell by outputting it to the logging processing unit 138 when it receives the Confirm message (S16 or S24). The identifier of the cell at the handover source is extracted by the connection management control unit 136 and held by the logging processing unit 138 when the base station 100 receives a connection request of the cell from the terminal 200 in the call processing, for example. Also, the identifier of the cell at the handover destination is included in the Measurement Report message. Thus, the logging processing unit 138 receives an instruction of determination of execution of the handover (S13 and the like) and the like from the handover control unit 135 and upon this trigger, it can store the logging information of the “HO source” and the “HO destination” in the table.

The “occurrence time” is stored when the handover control unit 135 determines execution of handover (S13 or S21) or when the Confirm message is received (S16 or S24), for example. For example, when the handover control unit 135 determines execution of handover, a message of execution instruction is outputted from the message creating unit 131, and thus, the device monitoring control unit 137 can output the output time of the message as time information. Also, when the message creating unit 131 receives the Confirm message, the device monitoring control unit 137 can output the reception time of the message as the time information.

In the example in FIG. 11A, the terminal 200 with the terminal identifier “TMSI (x01)” executes handover from the cell with the identifier of “eNB1 cell1 ” to the cell with the identifier of “eNB1 cell2” at the time “10 hour”. Moreover, the terminal 200 executes handover from the cell “eNB1 cell2” to the cell “eNB1 cell1” at the time “10 hour, 2 second”.

In the example in FIG. 11B, moreover, the terminal with the terminal identifier (TMSI (x02)” executes handover from the cell “eNB1 cell1” to the cell “eNB1 cell2” at the time “10 hour, 5 minute”. And after “2 seconds”, the handover is executed from the cell “eNB1 cell2” to the cell “eNB1 cell1”.

The change determination unit 139 determines a change of the measurement parameter by reading this logging information from the table 1381 after a predetermined time elapsed.

For example, supposing that a threshold time is “3 seconds” and a predetermined number of times is “2” as conditions for a change, the logging information in the items “1” to “4” indicated in FIG. 11B satisfies the conditions. The change determination unit 139 compares the change conditions with the logging information and if the logging information satisfies the conditions, the unit outputs a change instruction to change the measurement parameter or the hysteresis value used by the terminal 200 for quality measurement, for example, to the measurement instruction unit 134. The measurement instruction unit 134 transmits a changed hysteresis value to the terminal 200 (S31) as a new hysteresis value to the cell #1 on the basis of the change instruction.

The terminal 200 adds the changed hysteresis value to the quality measurement value of the cell #1 after that, compares the added value with the quality measurement values of other cells and determines handover.

If the logging information does not satisfy the conditions in the processing at S30, the change determination unit 139 does not output the change instruction, and the measurement instruction unit 134 transmits the same hysteresis value as the hysteresis value transmitted at S10, for example, to the terminal 200.

FIG. 12 is a diagram illustrating a relationship example between the cell and the movement change of the terminal 200. When the hysteresis value to the cell #1 is changed, as illustrated in FIG. 12, the cell range of the cell #1 is expanded from the solid line to the dotted line. As a result, even if the terminal 200 moves as illustrated by an arrow, since it moves within the cell #1, handover is not executed (the Measurement Report message is not transmitted). Alternatively, since the range of the cell #1 is changed to the space surrounded by the dotted line, transmission by the terminal 200 of the Measurement Report message (S12 and the like) is delayed than the case of the solid line.

Therefore, since handover is not executed (or deleted) for this base station 100 and the terminal 200, the base station 100 and the MME 410 or the like in the network does not execute processing for the handover, and the processing can be reduced by that portion. Also, since the terminal 200 does not perform handover, power consumption can be reduced by that portion. Moreover, since adjustment of the hysteresis value is not made manually in the base station 100, costs can be reduced for the operator operating the base station 100 and the like.

<1.2 When “Across-Two-Cells” is Performed Between Two Base Stations>

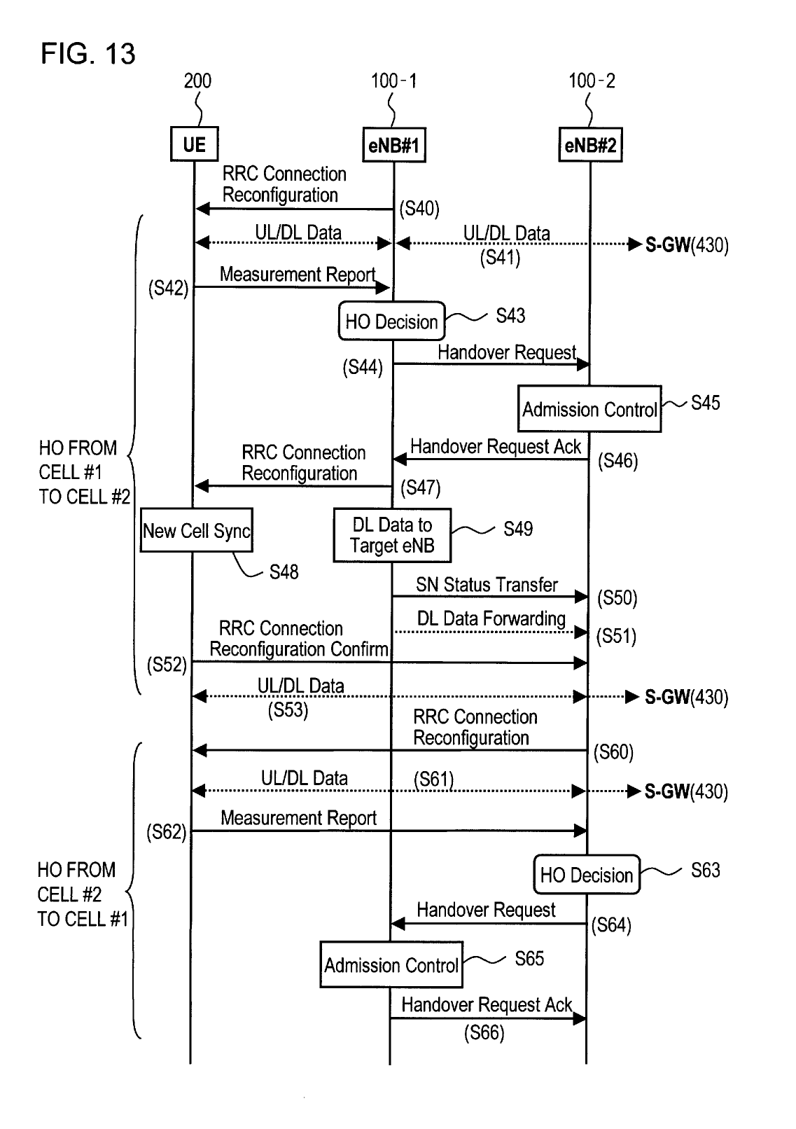

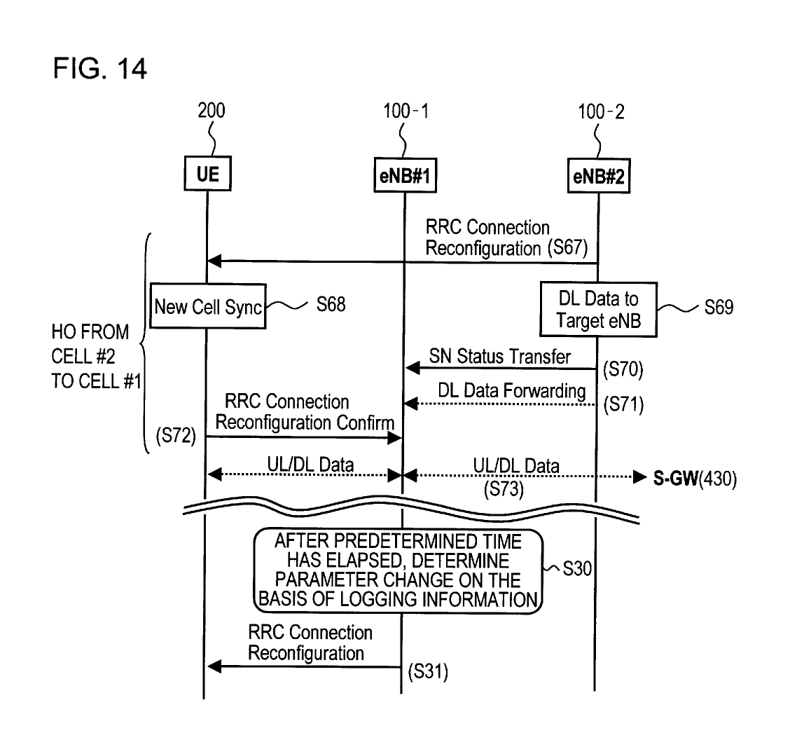

Subsequently, a case in which the “across-two-cells” is performed between two base stations will be described. FIG. 13 and FIG. 14 are sequence diagrams illustrating an operation example of such a case.

FIGS. 13 and 14 illustrate a case in which the terminal 200 executes handover from the cell #1 of the base station (eNB#1) 100-1 to the cell #2 of the base station (eNB#2) 100-2 and further executes handover from the cell #2 to the cell #1 in a time shorter than the threshold time. Similarly to the above-described 1.1, it is supposed that the base station 100-1 holds the identifier of the terminal 200 in advance through the call processing or the like, and the terminal 200 holds the identifier of the adjacent cell #2 through the notification information.

The base station 100-1 transmits the Reconfiguration message to the terminal 200 (S40). The message includes a measurement parameter for the cell #1 of the base station 100-2 or the hysteresis value used in quality measurement, for example.

After that, if there is data transmission or reception, the data is transmitted or received between the terminal 200 and the base station 100-1 (S40). The base station 100-1 outputs data (UL data) received from the terminal 200 to S-GW 430 and transmits data (DL data) outputted from the S-GW 430 to the terminal 200.

Then, if the reception quality measurement value of the cell #2 is better than the value obtained by adding the hysteresis value to the reception quality measurement value of the cell #1, the terminal 200 requests handover from the cell #2 (S42). The Measurement Report message, which is a handover request message, includes the identifier of the terminal 200, the identifier of the cell #2, and the reception quality measurement value of the cell #2.

If the base station 100-1 receives the message, it determines execution of handover (S43).

Then, the base station 100-1 transmits a Handover Request message to the base station 100-2 containing the cell #2 at the handover destination (S44). The message includes the identifier of the terminal 200. As a result, the base station 100-2 at the handover destination can identify the terminal 200 to execute the handover. Also, in the message itself, identifiers of the cells at the handover source and the handover destination are included as a transmission source and a destination. For example, the handover control unit 135 makes a request to the message creating unit 131, the message creating unit 131 reads the logging information such as “HO destination” and “HO source” from the logging processing unit 138 and creates the message so as to include those information, and the message is transmitted.

Then, the base station 100-2 checks resources required for communication with the terminal 200 and the like (S45). For example, the handover control unit 135 or the resource management unit 133 checks the resources and the like.

Then, the base station 100-2 transmits a Handover Request Ack message, which is a response message to the Handover Request message, to the base station 100-1 (S46). For example, when the handover control unit 135 of the base station 100-2 requests the message creating unit 131 to create the message, the message is transmitted. Also, the handover control unit 135 of the base station 100-1 receives the message from the message creating unit 131.

When the base station 100-1 receives the Handover Request Ack message, it transmits the Reconfiguration message including the execution instruction of handover to the terminal 200 (S47). For example, when the handover control unit 135 of the base station 100-1 requests the message creating unit 131 to create the message, the message is transmitted to the terminal 200.

When the terminal 200 receives the message, the terminal executes processing or the like to establish synchronization with the cell #2 (S48).

On the other hand, the base station 100-1 transmits the DL data to the base station 100-2 at the handover destination (S49). For example, the baseband processing unit 104 determines execution of handover (S43) and then, holds the DL data received from the S-GW 430 and transmits the held DL data to the base station 100-2.

Then, the base station 100-1 transmits status information relating to the terminal 200 such as the maximum transmission rate of the terminal 200 and various types of level information and the like to the base station 100-2 (S50). For example, at the call processing, the handover control unit 135 or the connection management control unit 136 holds the status information and requests the message creating unit 131 to create a transmission message of the information, and the message is transmitted.

Also, when the base station 100-1 is receiving the DL data from the S-GW 430 at S49 and after, for example, it transmits the DL data to the base station 100-2 (S51).

On the other hand, when the terminal 200 establishes synchronization with the base station 100-2 at the handover destination, the terminal transmits the Confirm message indicating completion of the handover to the base station 100-2 (S51). As a result, the terminal 200 completes the handover from the cell #1 to the cell #2.

After that, the terminal 200 transmits or receives data to or from the base station 100-2 containing the cell #2 at the handover destination (S53).

Then, the base station 100-2 transmits the Reconfiguration message including the measurement parameter to the terminal 200 (S60). The message includes the hysteresis value to the cell #2.

Then, if there is data to be transmitted, the terminal 200 or the base station 100 transmits or receives the data (S61).

Then, if the reception quality measurement value of the cell #1 is better than the value obtained by adding the hysteresis value to the reception quality measurement value of the cell #2, the terminal 200 requests handover to the cell #1 (S62). For example, when the handover control unit 234 requests the message creating unit 131 to create the Measurement Report message including the reception quality measurement value of the cell #1 and the like, the message is transmitted.

When the base station 100-2 receives the Measurement Report message, it determines execution of handover to the cell #1 (S63) and transmits the Handover Request message to the base station 100-1 containing the cell #1 at the handover destination (S64). The message includes the identifier of the terminal 200 and the like.

When the base station 100-1 receives the Handover Request message, it executes processing of resource check and the like (S65).

Then, the base station 100-1 transmits the Handover Request Ack message, which is a response message to the Handover Request message, to the base station 100-2 (S66).

When the base station 100-2 receives the Handover Request Ack message, it transmits the Reconfiguration message that instructs execution of handover to the cell #2 to the terminal 200 (S67).

When the terminal 200 receives the Reconfiguration message that instructs execution of handover, it executes synchronization processing and the like to the base station 100-1 containing the cell #2 at the handover destination (S68).

On the other hand, the base station 100-2 transmits the DL data to the base station 100-1 at the handover destination (S69, S71) and transmits status information relating to the terminal 200 (S70).

Also, when synchronization with the cell #2 is established, the terminal 200 transmits the Confirm message, which is a handover completion message, to the base station 100-1 (S72). As a result, the terminal 200 completes handover from the cell #2 to the cell #1. After that, the terminal 200 transmits or receives data to or from the base station 100-1 containing the cell #1 at the handover destination (S73).

Then, the base station 100-1 determines a change of a measurement parameter of handover or a hysteresis value to the reception quality measurement value of the cell #1, for example, on the basis of the logging information after a predetermined time elapsed similarly to the above-described 1.1 (S30).

In this example, too, similarly to the above-described 1.1, the change determination unit 139 makes determination on the basis of the logging information stored in the table 1381. An example of the table 1381 is illustrated in FIGS. 11A and 11B. In this case, the two base stations 100-1 and 100-2 hold the table 1381 having the same logging information. For example, storing in the table 1381 is performed as follows.

That is, when execution of handover is determined (S43), the handover control unit 135 of the base station 100-1 stores the identifier of the cell in the “HO destination” and “HO source” in the table 1381. Also, the handover control unit 135 stores time when the Handover Request message is transmitted (S44) in the “occurrence time”. Also, the handover control unit 135 of the base station 100-2 at the handover destination stores the identifier of the cell in the “HO source” and “HO destination”, respectively, on the basis of the transmission source and the transmission destination of the received Handover Request message. Moreover, the handover control unit 135 of the base station 100-2 stores the reception time of the message in the “occurrence time”.

For example, supposing that the condition for change determination in the change determination unit 139 is that handover with the occurrence time interval of the handover within “3 seconds” occurs “twice” or more, the logging information in FIG. 11B satisfies this condition. At this time, the change determination unit 139 outputs a change instruction to change to a value smaller than the hysteresis value transmitted at S10 to the measurement instruction unit 134 similarly to the above-described 1.1.

As a result, the base station 100-1 transmits the Reconfiguration message including the changed hysteresis value to the terminal 200 (S31).

As for the change of the hysteresis value, too, the cell range of the cell #1 is changed from the solid line to the dotted line as illustrated in FIG. 12, for example. As a result, since the terminal 200 moves in the cell #1, the Measurement Report message (S42) is not transmitted to the base station 100-1. Therefore, since the processing at S42 and after is not performed at the base station 100-1 and the terminal 200 and handover does not occur, processing is reduced in the base station 100-1 and the like and power consumption can be reduced in the terminal 200. Also, since adjustment of the hysteresis value in the base station 100-1 is made in the base station 100 and the like, a cost for manual adjustment can be reduced.

<2. Operation in the Case of “Across-Three-Cells”>

Subsequently, an operation in the case of the “across-three-cells” will be described. In the case of this “across-three-cells”, too, there are a case of the operation in one base station 100 (FIG. 4A), a case of the operation in two base stations 100-1 and 100-2 (FIGS. 4B to 5A), and a case of the operation in three base stations 100-1 to 100-3. Each ease will be described separately.

<2.1 When the “Across-Three-Cells” is Performed in One Base Station 100>

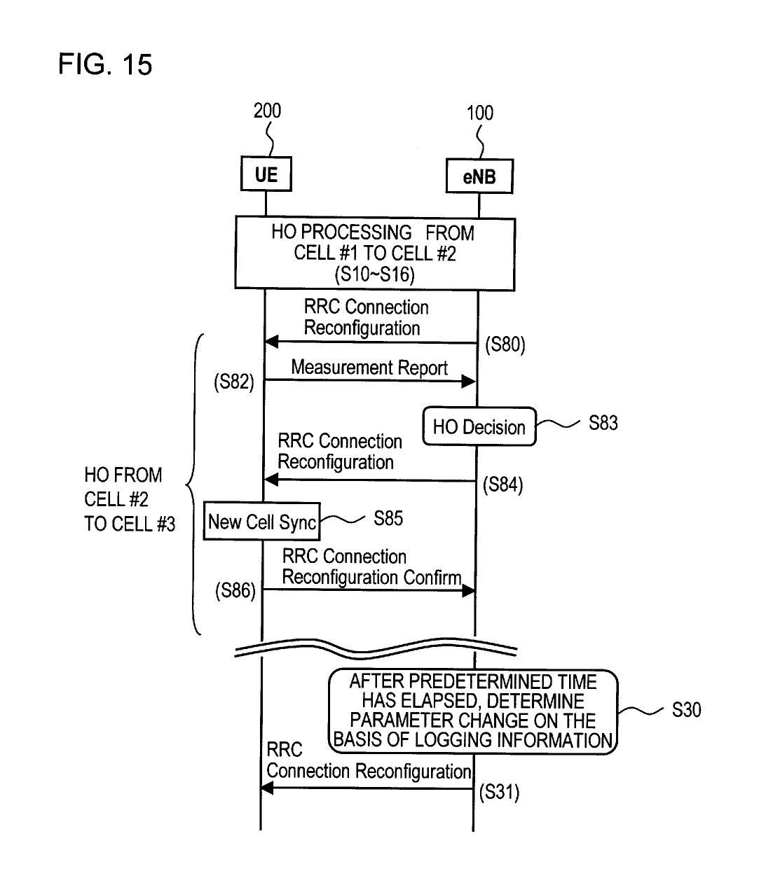

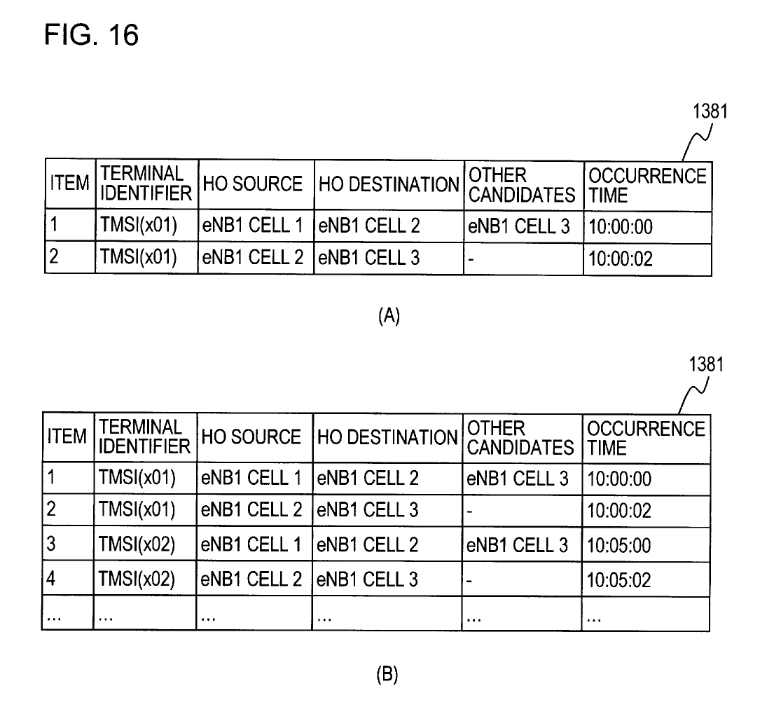

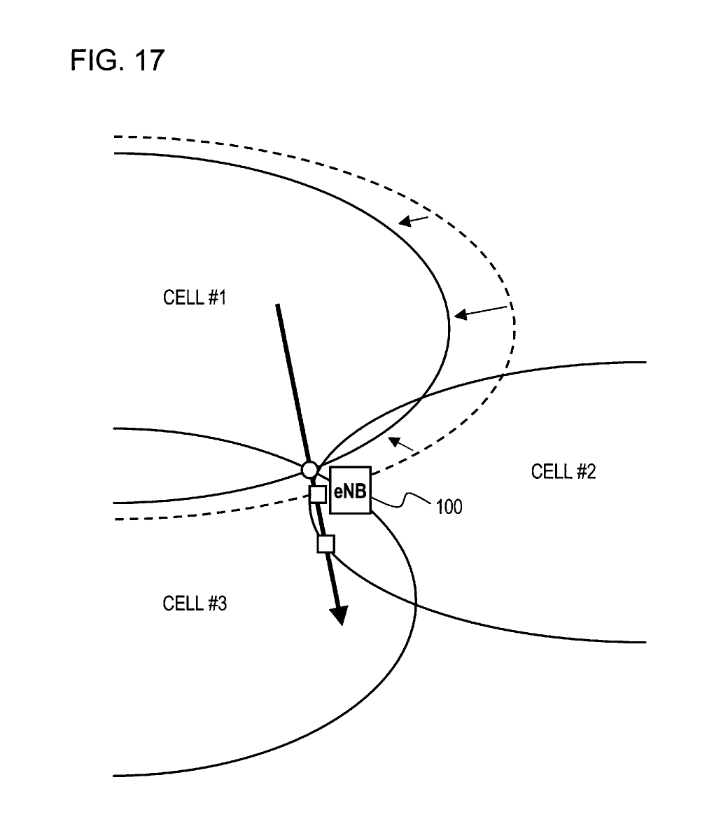

First, the case in which the “across-three-cells” is performed in one base station 100 will be described. FIG. 15 is a sequence example of that case, FIGS. 16A and 16B are examples of the table 1381, and FIG. 17 is a diagram illustrating a relationship example between the cell and the movement change of the terminal 200.

A sequence example when the “across-three-cells” is performed in one base station 100 is as follows. First, the terminal 200 and the base station 100 execute handover processing from the cell #1 to the cell #2. This processing is similar to the above-described processing (S10 to S16) in 1.1 (the case of the “across-two-cells” in one base station). As a result, the terminal 200 completes the handover from the cell #1 to the cell #2, and the base station 100 is brought into a state in which data can be transmitted or received (S17).

However, in the processing at S12, when the terminal 200 transmits the Measurement Report message to the base station 100, it also transmits the identifier and the communication quality measurement value of the cell #3 other than the identifier and the communication quality measurement value to the cell #2. As a result, if there is plurality of handover destinations for the terminal 200, the base station 100 can store logging information relating to the plurality of the handover destination candidates. For example, the logging processing unit 138 stores “eNB1 cell3”, which is an example of the identifier of the cell #3, in the field of “other candidates” of the item “1” in the table 1381 as illustrated in FIG. 16A.

After that, the terminal 200 performs handover from the cell #2 to the cell #3 of the base station 100 in a time shorter than the threshold value. That is, the base station 100 transmits the Reconfiguration message including the hysteresis value and the like relating to the cell #2 to the terminal 200 (S80).

Then, the terminal 200 compares the value obtained by adding the hysteresis value to the communication quality of the cell #2 and the communication quality of the cell #3 and if the result indicates that the communication quality of the cell #3 is better, the terminal transmits the Measurement Report message (S82). The message includes the identifier of the cell #3, the communication quality measurement value of the cell #3, the identifier of the terminal 200 and the like, for example.

When base station 100 receives the Measurement Report message, it determines (or allows) that the terminal 200 performs handover from the cell #2 to the cell #3 (S83).

Then, the base station 100 transmits the Reconfiguration message to instruct execution of the handover to the cell #3 to the terminal 200 (S84).

When the terminal 200 receives the message, it executes synchronization processing with the cell #3 (S85) and then, transmits the Confirm message indicating completion of the handover to the base station 100 (S86).

As a result, the handover from the cell #1 to the cell #2 and further from the cell #2 to the cell #3 of the terminal 200 is executed, and the logging processing unit 138 stores the logging information up to the item “2” in the table 1381 as illustrated in FIG. 16A, for example.

Then, the base station 100 determines a change of the measurement parameter used for the handover on the basis of the logging information after a predetermined time elapsed (S30). FIG. 16B illustrates the example of the table 1381 that stored the logging information after the predetermined time elapsed. Also, as a change condition, if the occurrence interval of the handover is within “5 seconds” and the handover occurs “twice” or more, the hysteresis value is supposed to be changed. In this case, since the logging information illustrated in FIG. 16B satisfies the standard, the change determination unit 139 outputs a change instruction of the hysteresis value such as an instruction to make the hysteresis value relating to the cell #1 smaller than that transmitted at S10, to the measurement instruction unit 134.

Then, the instruction measurement unit 134 transmits the Reconfiguration message including the changed hysteresis value to the terminal 200 (S31).

Since the terminal 200 determines the handover from the changed hysteresis value, as illustrated in FIG. 17, for example, the cell range of the cell #1 is changed from the dotted line to the solid line, and the position where the handover occurs is changed from the position with a square mark to the position with a circular mark. Therefore, similarly to the above-described 1.1, the number of handover sessions can be reduced in the terminal 200 and the like, power consumption can be reduced in the terminal 200, and a processing load can be alleviated in the base station 100 and the like. Also, since the base station 100 automatically adjusts the hysteresis value, the cost for the manual work by the operator can be reduced in this base station 100 and the like.

<2.2When “Across-Three-Cells” is Performed in Two Base Stations>

If the “across-three-cells” is performed in two base stations 100-1 and 100-2, there are three patterns in the relationship between the cell and the base station 100 (FIGS. 4B to 5A, for example). Each pattern will be described separately.

<2.2.1 When the Base Station 100-1 Contains the Cells #1 and #2 and the Base Station 100-2 Contains the Cell#3>

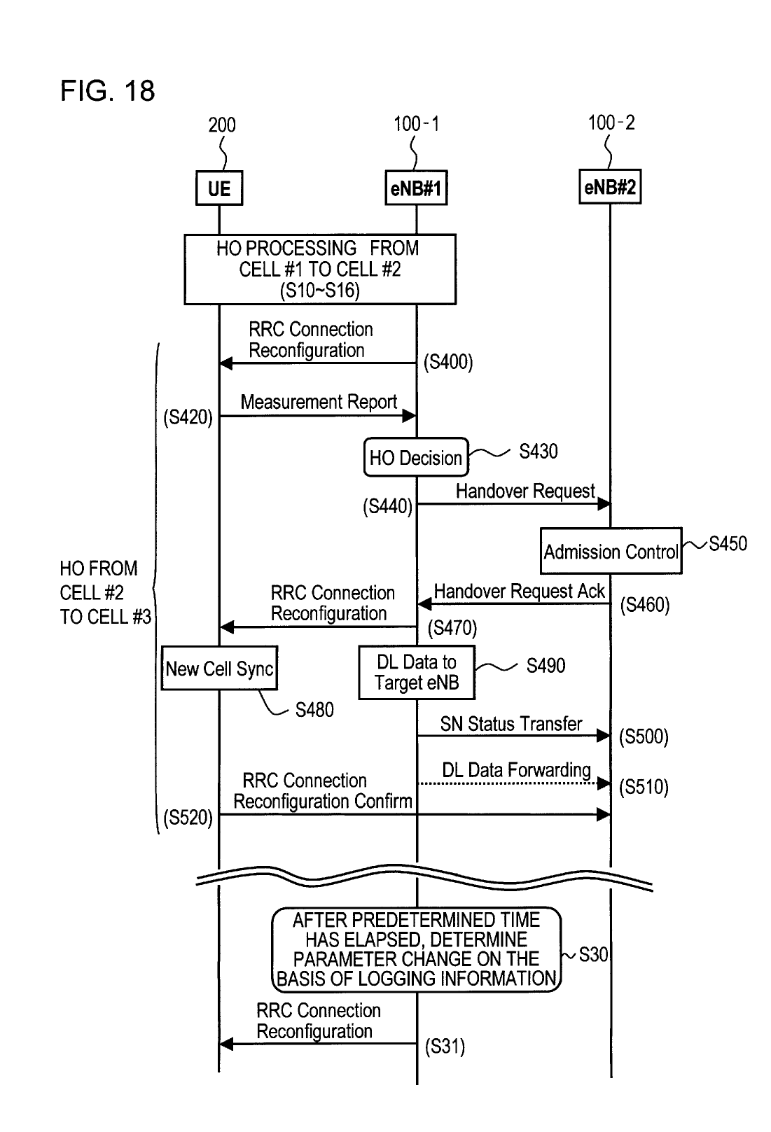

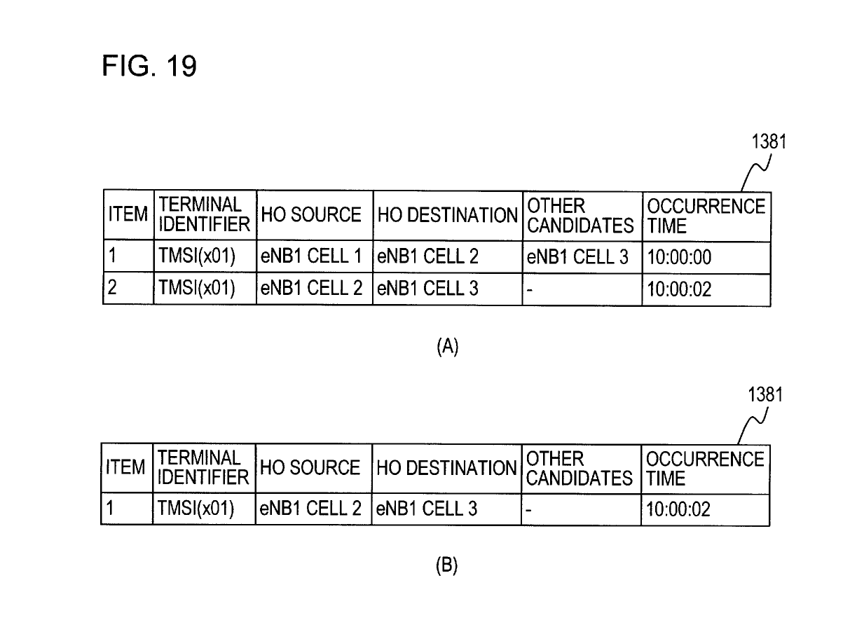

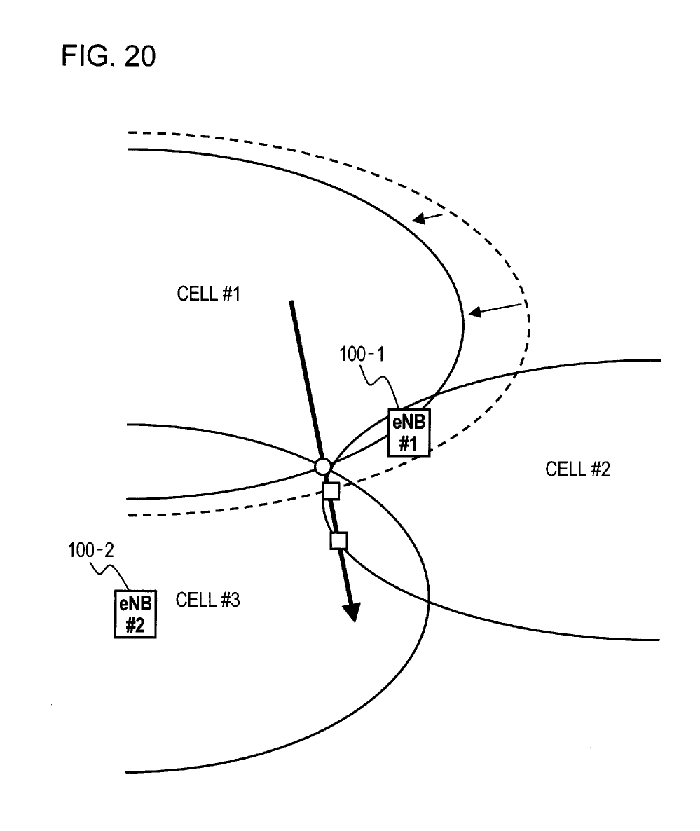

In the case in which the “across-three-cells” is performed in the two base stations 100-1 and 100-2, a case in which the base station 100-1 contains the cells #1 and #2 and the base station 100-2 contains the cell #3 (FIG. 4B, for example) will be described as an example. FIG. 18 is a sequence diagram including an operation example when the terminal 200 performs handover from the cell #1 to the cell #2 and performs handover from the cell #2 to the cell #3 in a time shorter than the threshold time. Also, FIGS. 19A and 19B are diagrams illustrating examples of the table 1381, and FIG. 20 is a diagram illustrating relationship example between the cell and the movement change of the terminal 200, respectively.

In the operation when the handover is executed from the cell #1 to the cell #2, the terminal 200 executes the processing similar to S10 to S16 in the above-described 1.1 (the case in which the “across-two-cells” is performed in one base station). However, similarly to the above-described 2.1 (the case in which the “across-three-cells” is executed in one station), in the processing at S12, the terminal 200 transmits the Measurement Report message including the identifier of the cell #3 and the communication quality measurement value and the like other than the cell #2.

Then, the terminal 200 executes handover from the cell #2 to the cell #3. In this case, the cell #2 is contained in the base station 100-1, and the cell #3 is contained in the base station 100-2. Thus, the handover operation in this case is substantially the same as the operation (S40 to S52) of the handover from the base station 100-1 to the base station 100-2 in the above described 1.2 (when the “across-two-cells” is performed between two base stations).

That is, the base station 100-1 transmits the Reconfiguration message including the hysteresis value and the like relating to the cell #2 to the terminal 200 (S400).

Then, the terminal 200 transmits the Measurement Report message including the communication quality measurement value and the like of the cell #3 to the base station 100-1 (S420).

When base station 100 receives the message, it determines handover from the cell #2 to the cell #3 (S430) and outputs the Handover Request message to the base station 100-2 containing the cell #3 at the handover destination(S440). Similarly to the above-described 1.2, the device monitoring control unit 137 of the base station 100-1 stores the time when the message is transmitted in the “occurrence time” field of the table 1381, for example. The base station 100-2 that received the message stores the time when the device monitoring control unit 137 received the message in the field of the “occurrence time”, for example.

When the base station 100-2 receives the Handover Request message, it executes the check processing of the resource and the like for the terminal 200 (S450). Then, the base station 100-2 transmits the Handover Request Ack message, which is a response message to the message, to the base station 100-1 (S460).

When the base station 100-1 receives the Handover Request Ack message, it transmits the Configuration message to the terminal 200 to execute handover to the cell #3 (S470).

When terminal 200 receives the message, it executes the synchronization processing with the cell #3 (S480), and the base station 100-1 transmits status information relating to the terminal 200 to the base station 100-2 (S500). Also, if the base station 100-1 holds the DL data to be transmitted to the terminal 200, the base station transmits the DL data to the base station 100-2 (S490, S510).

When the synchronization processing with the cell #3 and the like is finished, the terminal 200 notifies completion of the handover to the base station 100-2 that contains the cell #3 (S520).

As a result, the terminal 200 completes the handover from the cell #2 to the cell #3.

FIG. 19A is a diagram illustrating an example of the table 1381 held by the logging processing unit 138 in the base station 100-1 after the handover of the cell #3 is finished (after S520). Also, FIG. 19B is a diagram illustrating an example of the table 1381 held by the logging processing unit 138 of the base station 100-2 after the handover to the cell #3 is finished. The base station 100-1 receives information relating to the cells #2 and #3 at the handover destination from the terminal 200 through the processing at S12 and S420. Therefore, the base station 100-1 can store each of the logging information for each handover from the cell #1 to the cell #2 and from the cell #2 to the cell #3 in the table 1381 as illustrated in FIG. 19A. On the other hand, the base station 100-2 holds the logging information for the handover from the cell #2 to the cell #3 through the processing at S440 as illustrated in FIG. 19B.

In this 2.2.1, too, similarly to the above-described 1.1 and the like, the base station 100-1 at the handover source determines a change of the hysteresis value on the basis of the logging information after a predetermined time elapsed (S30). For example, if the logging information as illustrated in FIG. 19A is held after the predetermined time elapsed, and under the condition similar to the above-described 1.2 and the like, the change determination unit 139 outputs the change of the hysteresis value to the measurement instruction unit 134. As a result, the measurement instruction unit 134 transmits the Reconfiguration message including the changed hysteresis value to the terminal 200 (S31).

FIG. 20 is a diagram illustrating a relationship example between the cell and the movement change of the terminal 200. In this case, too, the measurement instruction unit 134 or the change determination unit 139 transmits a hysteresis value lower than the hysteresis value to the cell #1 transmitted at S10, for example, to the terminal 200. Therefore, the cell range of the cell #1 is changed from the dotted line to the solid line, and the position of the handover is changed from the square mark to the circular mark. Thus, the number of handover sessions is reduced, and reduction of the power consumption of the terminal 200 and processing of the base station 100 can be realized. Also, the hysteresis value is adjusted automatically, and a cost can be reduced.

<2.2.2 When the Base Station 100-1 Contains the Cell #1 and the Base Station 100-2 Contains the Cells #2 and #3>

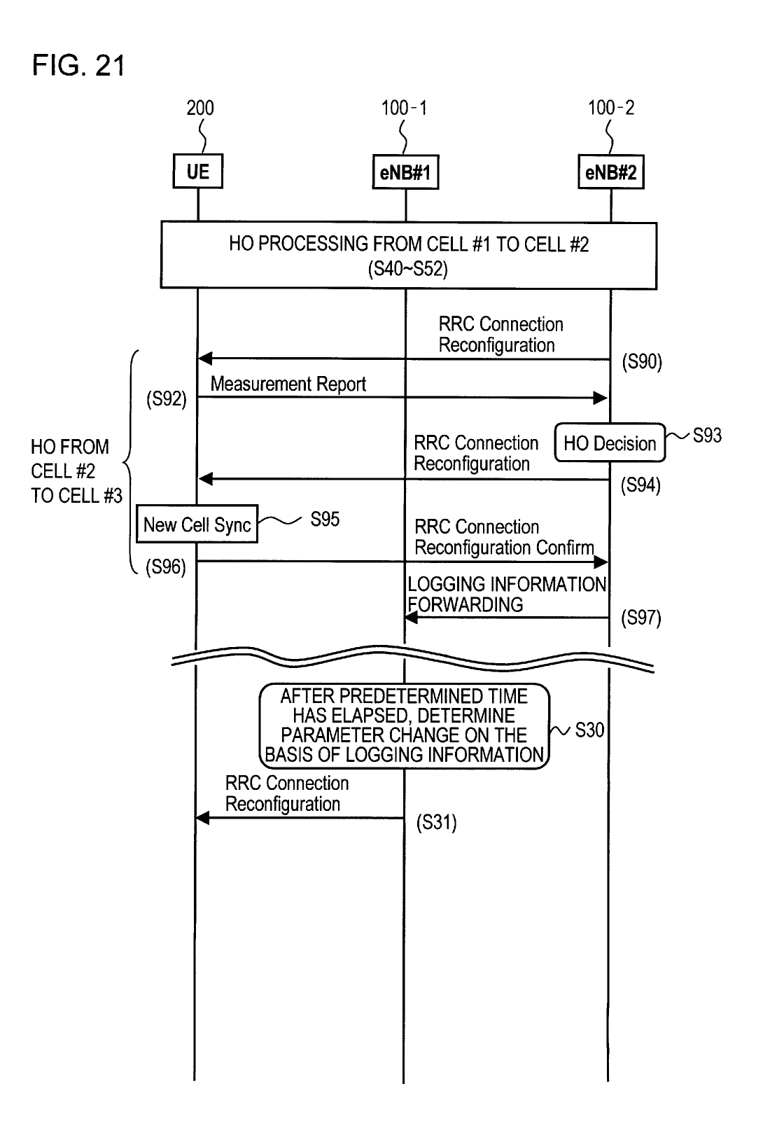

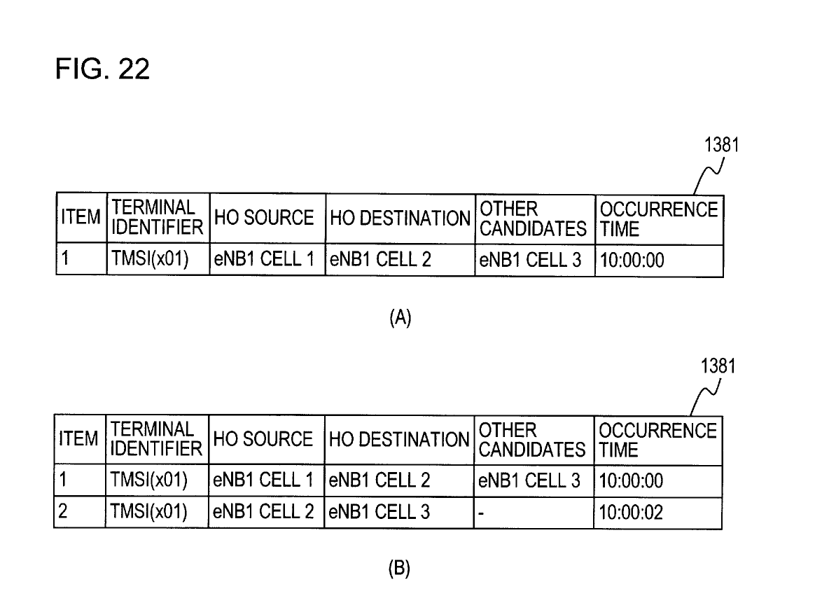

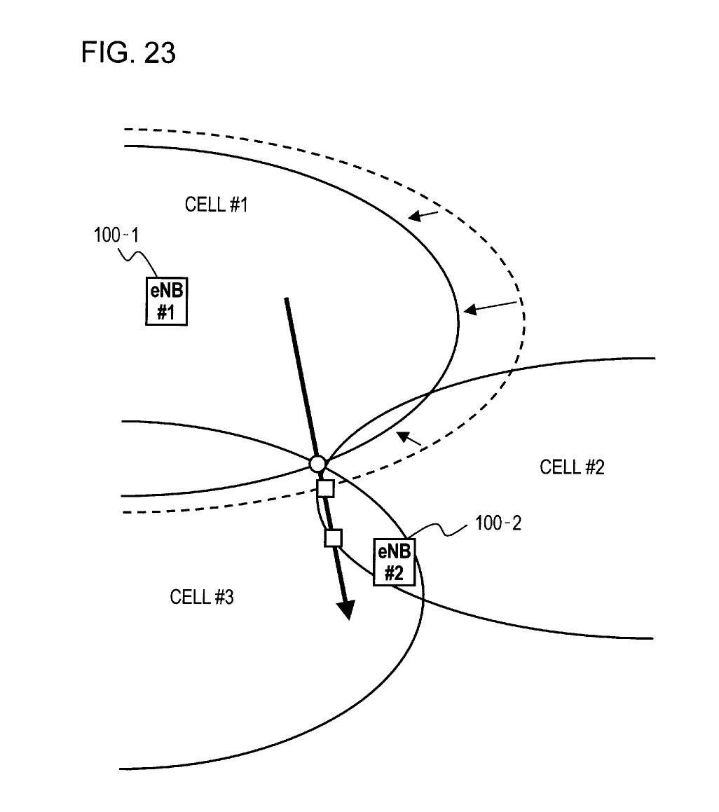

Subsequently, the case in which the base station 100-1 contains the cell #1 and the base station 100-2 contains the cells #2 and #3 (FIG. 4C, for example) will be described. FIG. 21 is a sequence diagram illustrating an operation example, FIGS. 22A and 22B illustrate the table 1381, and FIG. 23 is a diagram illustrating a relationship example between the cell and the movement change of the terminal 200.

When the terminal 200 moves from the cell #1 to the cell #2, it performs handover from the base station 100-1 containing the cell #1 to the base station 100-2 containing the cell #2. Therefore, the base station 100-1, the base station 100-2, and the terminal 200 execute processing from S40 to S52 in the above-described 1.2 (when the “across-two-cells” is performed between two base stations).

After the terminal 200 executes the handover to the cell #2, it performs the handover to the cell #3, but since the two cells #2 and #3 share the same base station 100-2, the base station 100-2 and the terminal 200 execute substantially the same processing as the above-described 1.1 (when the “across-two-cells” is performed by one base station).

That is, the base station 100-2 transmits the Reconfiguration message including the hysteresis value of the cell #2 and the like to the terminal 200 (S90).

The terminal 200 transmits the Measurement Report message including the identifier of the cell #3 and the quality measurement value and the like to the base station 100-2 in order to request the handover to the cell #3 (S92).

When the base station 100-2 receives the message, it determines handover of the terminal 200 from the cell #2 to the cell #3 (S93) and transmits the Reconfiguration message to the terminal 200 in order to instruct execution of the handover to the cell #3 (S94).

When the terminal 200 receives the message, it executes the synchronization processing to the cell #3 (S95) and transmits the Confirm message to the base station 100-2 in order to notify completion of the handover (S96).

As a result, the terminal 200 finishes the handover from the cell #2 to the cell #3 and it can transmit or receive data to or from the base station 100-2 containing the cell #3.

FIG. 22A illustrates an example of the table 1381 held by the base station 100-1, and FIG. 22B illustrates an example of the table 1381 held by the base station 100-2, respectively. In the case of this 2.2.2, when the terminal 200 performs handover from the cell #2 to the cell #3, communication is not conducted with the base station 100-1, and the base station 100-2 does not communicate with the base station 100-1, either. Thus, the base station 100-1 at the handover source holds the logging information on the handover from the cell #1 to the cell #2 in connection with the terminal 200 but cannot hold the logging information on the handover from the cell #2 to the cell #3. FIG. 22A is the example of the table 1381 in that case.

On the other hand, since the base station 100-2 communicate with the terminal 200 on the handover from the cell #1 to the cell #2 and from the cell #2 to the cell #3 (S40 to S52, S90 to S96), it holds the logging information on these two handovers. FIG. 22B is the example of the table 1381 in that case.

As described above, the two base stations 100-1 and 100-2 cannot hold the same logging information. In this 2.2.1, in this case, the base station 100-2 at the handover destination transmits the logging information held in the base station 100-1 at the handover source. As a result, the two base stations 100-1 and 100-2 performing the handover can hold the same logging information, and the base station 100-1 at the handover source can determine a change of the hysteresis value on the basis of the logging information (S30). As illustrated in FIG. 21, in this 2.2.1, after the processing at S96 is finished, the base station 100-2 transfers the held logging information (S97), but it may transmit the information after the processing at S93 is finished or after the processing at S94 is finished, for example. The subsequent processing is the same as in the above-described 2.2.1 and the like.

FIG. 23 is a diagram illustrating a relationship example between the cell and the movement change of the terminal 200 in this 2.2.2. By means of adjustment of the hysteresis value, the cell range of the cell #1 is changed from the dotted line (the cell range on the basis of the hysteresis value transmitted by the processing at S10, for example) to the solid line, for example. As a result, the number of handover sessions is reduced in the terminal 200, and power consumption can be realized. Also, the base station 100 can reduce processing. Also, since the hysteresis value is adjusted automatically, a cost can be reduced.

<2.2.3 When the Base Station 100-1 Contains the Cells #1 and #3 and the Base Station 100-2 Contains the Cell #2>

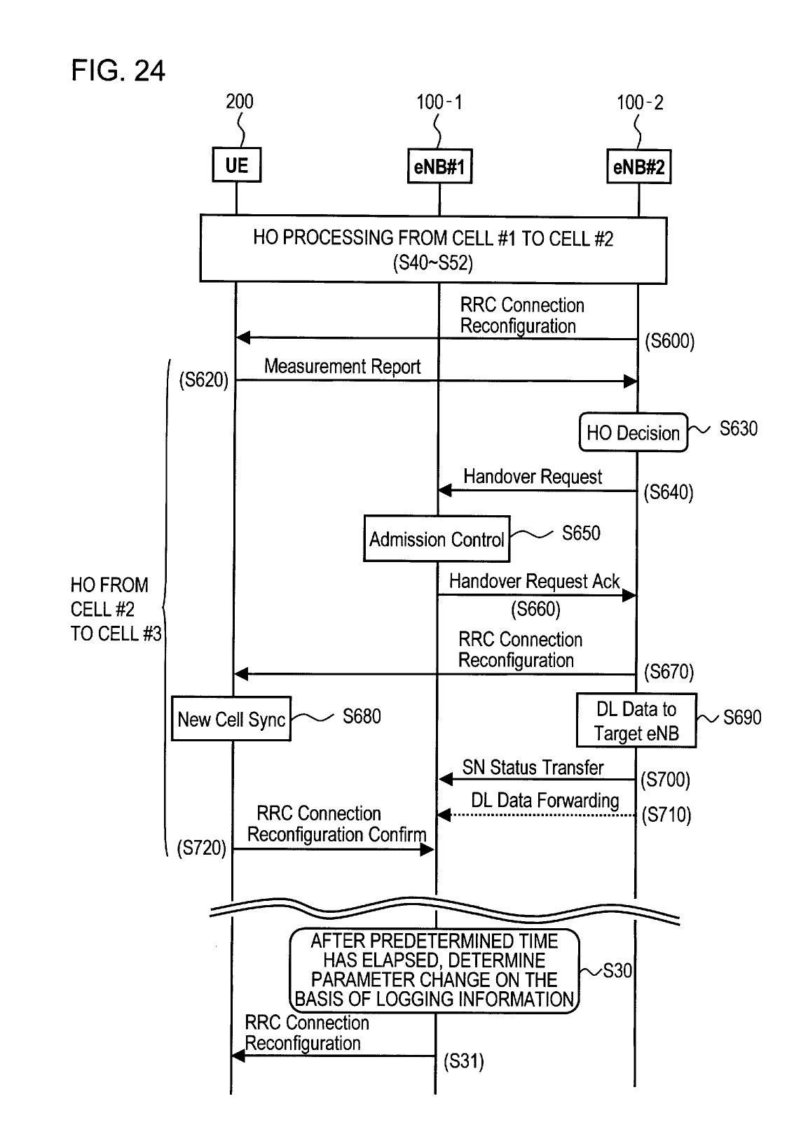

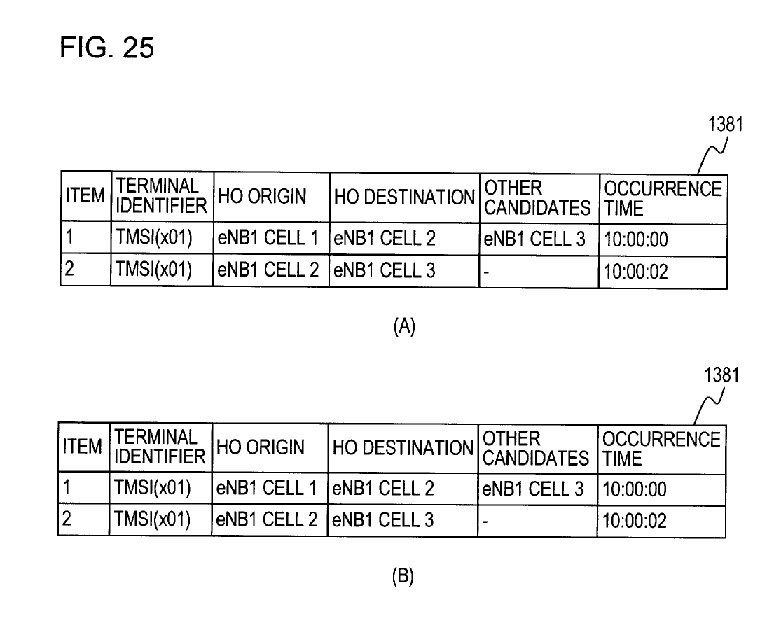

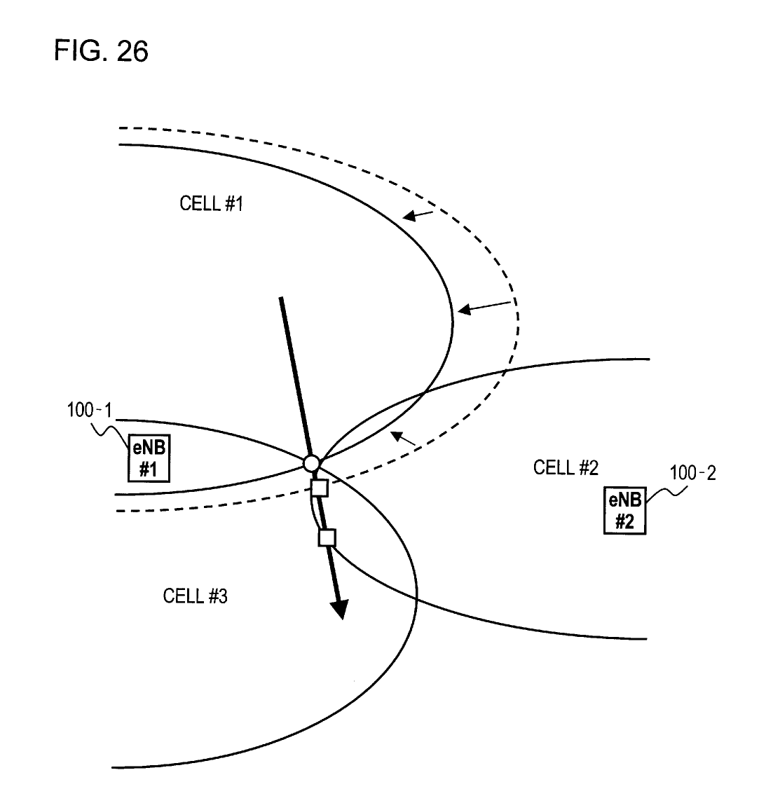

Subsequently, a case in which the base station 100-1 contains the cells #1 and #3 and the base station 100-2 contains the cell #2 (FIG. 5A, for example) will be described. FIG. 24 is a sequence diagram illustrating an operation example, FIGS. 25A and 25B are diagrams illustrating the table 1381, and FIG. 26 is a diagram illustrating a relationship example between the cell and the movement change of the terminal 200.

In this 2.2.3, the terminal 200 performs handover from the base station 100-1 containing the cell #1 to the base station 100-2 containing the cell #2 and then, performs handover to the base station 100-1 containing the cell #3.

In this case, concerning the handover from the cell #1 to the cell #2, the base station 100-1, the base station 100-2, and the terminal 200 execute the same processing (S40 to S52) as the above-described 1.2 (when the “across-two-cells” is performed between two base stations).

Then, concerning the handover from the cell #2 to the cell #3, the base station 100-1, the base station 100-2, and the terminal 200 execute substantially the same processing (S60 to S72) as the above-described 1.2 (when the “across-two-cells” is performed between two base stations) with only the exception that the cell at the handover destination is changed to the cell #3.

That is, the base station 100-2 transmits the Reconfiguration message including the hysteresis value of the cell #2 and the like to the terminal 200 (S600).

The terminal 200 transmits the Measurement Report message including the identifier of the cell #3 and the like to the base station 100-2 in order to request handover to the cell #3 (S620).

When the base station 100-2 receives the Measurement Report message, it determines execution of the handover to the cell #3 (S630) and transmits the Handover Request message to the base station 100-1 containing the cell #3 (S640). This message includes the identifier of the terminal 200 and the like similarly to the above-described 1.2 and the like.

When the base station 100-1 receives the Handover Request message, it checks resources and the like used for the communication with the terminal 200 (S650). Then, the base station 100-1 transmits the Handover Request Ack message, which is a response message to this message, to the base station 100-2 (S660).

When the base station 100-2 receives the Handover Request Ack message, it transmits the Reconfiguration message to the terminal 200 in order to instruct execution of the handover to the cell #3 (S670).

When the terminal 200 receives the message, it executes the synchronization processing with the cell #3 (S680). Also, the base station 100-2 at the handover source transmits the status information and the like relating to the terminal 200 to the base station 100-1 at the handover destination (S690 to S710).

The terminal 200 transmits the Confirm message to the base station 100-1 containing the cell #3 at the handover destination in order to notify the completion of the handover (S720).

In this 2.2.3, at the handover, the two base stations 100-1 and 100-2 transmit/receive the Handover Request message to each other (S44, S640). Therefore, the two base stations 100-1 and 100-2 hold the same logging information illustrated in FIGS. 25A and 25B, for example. As a result, the base station 100-1 can determine the change of the hysteresis value and the like on the basis of the logging information (S30), and the change determination unit 139 instructs the change to the measurement instruction unit 134 if the condition is satisfied similarly to the above-described 1.1 and the like. Then, the base station 100-1 transmits the Reconfiguration message including the changed hysteresis value and the like (S31).

FIG. 26 is a diagram illustrating a relationship example between the cell and the movement change of the terminal 200 in this 2.2.3. When the change determination unit 139 instructs the change so that the hysteresis value to the cell #1 becomes smaller than the hysteresis value transmitted at S10, for example, the cell range of the cell #1 is changed from the dotted line to the solid line. As a result, the terminal 200 can reduce the number of handover sessions, and the power consumption can be reduced. Also, the base stations 100-1 and 100-2 can reduce processing, and a cost can be also reduced.

<2.3 When the “Across-Three-Cells” is Executed by Three Base Stations 100>

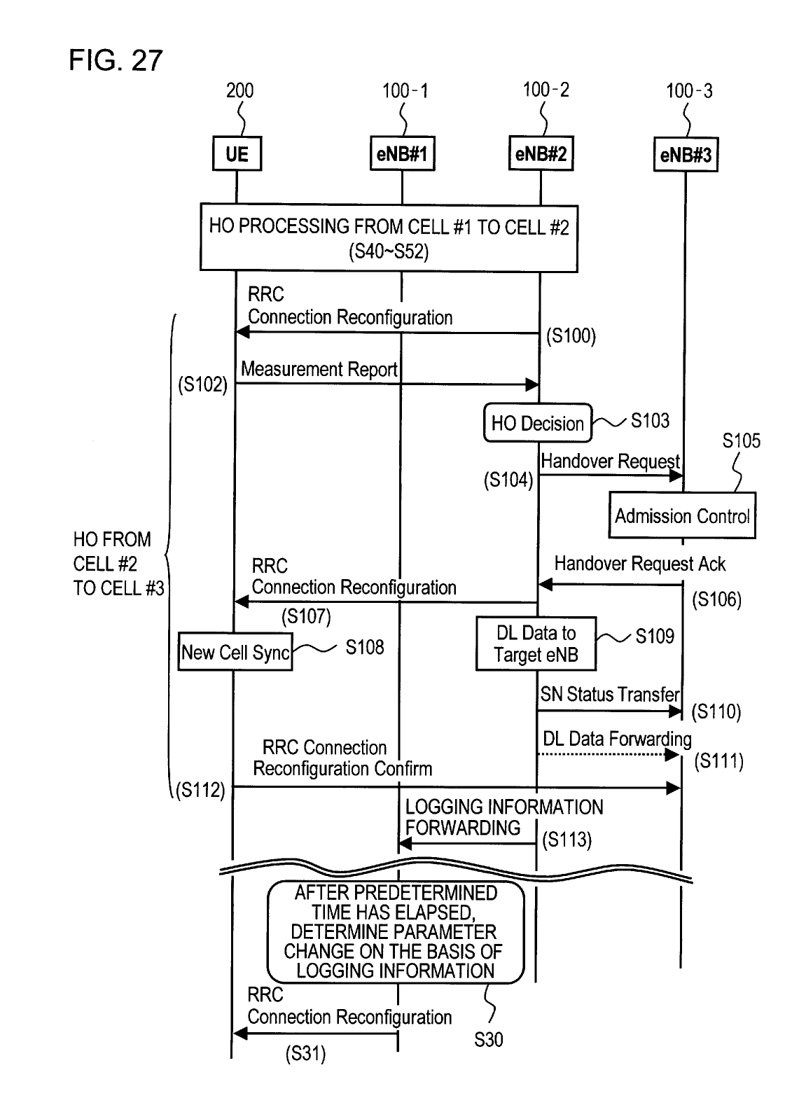

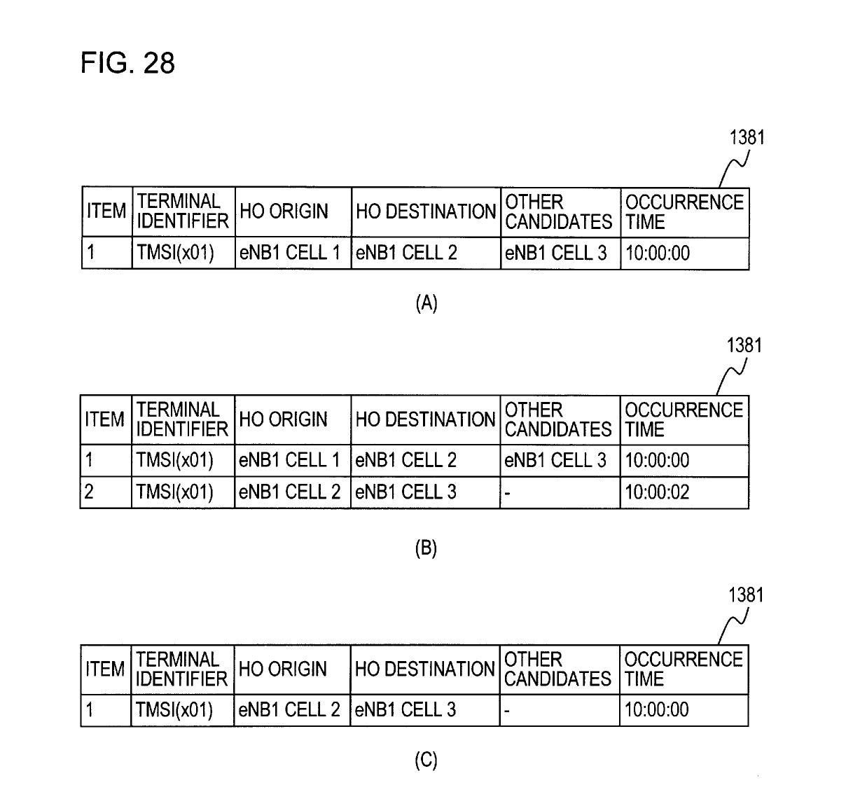

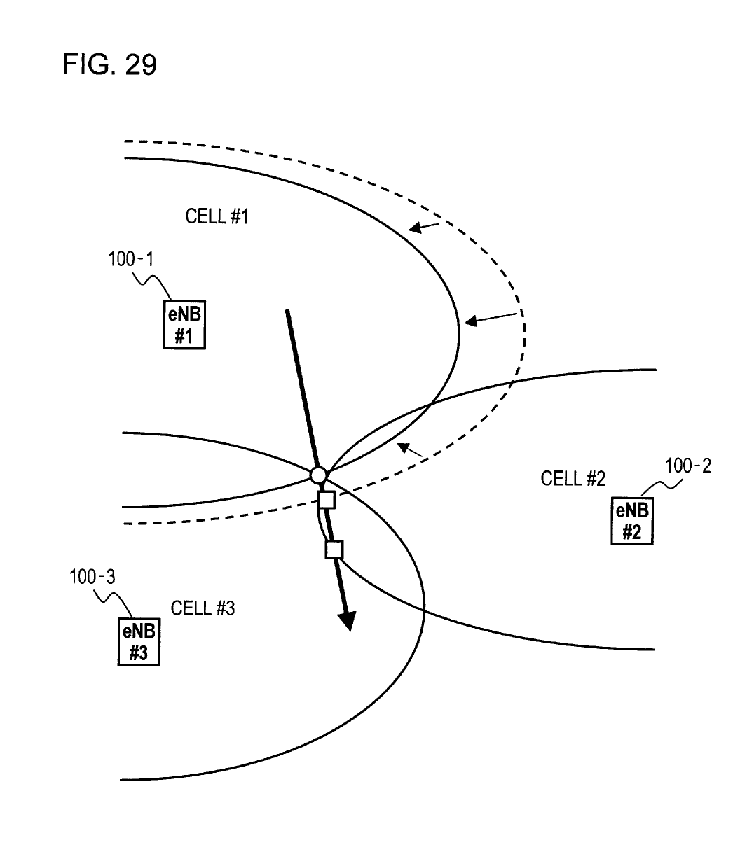

Subsequently, a case in which the “across-three-cells” is performed by three base stations 100-1 to 100-3 (FIG. 5B, for example) will be described. FIG. 27 is a sequence diagram illustrating an operation example, FIGS. 28A to 28C are examples of the table 1381, and FIG. 29 is a diagram illustrating a relationship example between the cell and the movement change of the terminal 200, respectively.

In the example of this 2.3, the terminal 200 performs handover from the base station 100-1 containing the cell #1 to the base station 100-2 containing the cell #2 and then, performs handover from the cell #2 to the base station 100-3 containing the cell #3. Therefore, each handover executes the processing substantially similar to the above-described 1.2 (“across-two-cells” is performed by two base stations).

First, when the terminal 200 is to perform the handover from the cell #1 to the cell #2, the processing from S40 to S52 in the above-described 1.2 is executed.

Then, when the terminal 200 finishes the handover to the cell #2, it performs the handover to the base station 100-3 containing the cell #3.

That is, the base station 100-2 transmits the Reconfiguration message including the hysteresis value to the cell #2 and the like to the terminal 200 (S100).

Then, the terminal 200 transmits the Measurement Report message including the identifier of the cell #3 and the like to the base station 100-2 in order to request the handover to the cell #3 (S102).

When the base station 100-2 receives the message, it determines execution of the handover to the cell #3 (S103) and transmits the Handover Request message to the base station 100-3 containing the cell #3 at the handover destination (S104). This message includes the identifier of the terminal 200 and the like.

When the base station 100-3 receives the Handover Request message, it checks the resources and the like used for the communication of the terminal 200 (S105) and transmits the Handover Request Ack message, which is a response message to the message (S106).

When the base station 100-2 receives the message, it transmits the Reconfiguration message to the terminal 200 in order to instruct execution of the handover to the cell #3 (S107).

When the terminal 200 receives the message, it executes the synchronization processing with the cell #3 and the like (S108) and then, in order to notify the completion of the handover to the cell #3, it transmits the Confirm message to the base station 100-3 (S112).

On the other hand, the base station 100-2 containing the cell #2 at the handover source transmits the status information of the terminal 200 and the like to the base station 100-3 containing the cell #3 at the handover destination (S109 to S111).

As described above, the terminal 200 performs the handover from the cell #1 to the cell #3 via the cell #2. An example of the logging information held by each of the base stations 100-1 to 100-3 when S112 is finished, for example, is illustrated in FIGS. 28A to 28C, respectively.

The base station 100-2 holds the logging information on the two handovers, that is, one from the cell #1 to the cell #2 and the other from the cell #2 to the cell #3 at S44 and S104, for example. Thus, the logging processing unit 138 of the base station 100-2 holds the logging information illustrated in FIG. 28B, for example.

On the other hand, since the base station 100-1 holds the logging information on the handover from the cell #1 to the cell #2 through the processing at S44, it holds the logging information illustrated in FIG. 28A, for example. Moreover, since the base station 100-3 also holds the logging information on the handover from the cell #2 to the cell #3 through the processing at S104, it holds the logging information illustrated in FIG. 28C, for example.

As described above, in the example in this 2.2.3, all the logging information is held in the base station 100-2. Thus, the base station 100-2 transmits the logging information to the base station 100-2 at the handover source. This transmission may be made after the Confirm message (S112) as illustrated in FIG. 27, for example (S113), or may be made after either of S103 to S110. As a result, the base station 100-1 at the handover source can make determination on the change of the measurement parameter (S30). The subsequent processing (S30, S31) is the same as in the above-described 1.1.

FIG. 29 is a diagram illustrating a relationship example between the cell and the movement change of the terminal 200 in the example in this 2.2.3. By means of the adjustment of the hysteresis value (S30, S31), the cell range of the cell #1 is changed from the dotted line to the solid line, for example, and the terminal 200 performs handover from the cell #1 to the cell #3 without passing through the cell #2. Therefore, the number of handover sessions is reduced, and reductions of power consumption of the terminal 200, processing in the base station 100, costs and the like can be realized.

In this first embodiment, in either case of the “across-two-cells” and the “across-three-cells”, the change determination unit 139 and the measurement instruction unit 134 adjust the hysteresis value of the cell #1 to the hysteresis value lower than the first transmitted hysteresis value (S10). For example, the change determination unit 139 and the like may transmit a hysteresis value lower than the first transmitted (S18 and the like) hysteresis value to the cell #2 (S31). Alternatively, the change determination unit 139 and the like may set the adjustment value to the cell #1 negative or the adjustment value to the cell #2 negative as an adjustment value instead of the hysteresis value itself as described above and transmit it (S31).

In the transmission of this hysteresis value (S10 and the like), if there are a plurality of cell candidates at the handover destination, the base station 100 may transmit all the hysteresis values of each cell at S10 and S80, respectively, for example. In this case, it is only necessary that when base station 100 determines the change of the measurement parameter (S30), the base station transmits a value changed from any one of the hysteresis value or the adjustment value to the cell #1 to the cell #3, for example, to the terminal 200 (S31). For example, the base station 100 transmits a positive adjustment value to the cell #3 or a hysteresis value larger than the threshold value to the cell #3 in the case of the example illustrated in FIG. 17 and the like (S31). It is only necessary that the terminal 200 determines the handover using a value to which the hysteresis value transmitted when the quality measurement value for the cell in connection and the like is added.

### Second Embodiment

Subsequently, a second embodiment will be described. The second embodiment is an example including an individual difference of the terminal 200. For example, in the terminal 200, a communicable range with the base station 100 might be different depending on the manufacturer who manufactures or sells the terminal 200. For example, the terminal 200-1 of a manufacturer A might have a communicable range narrower than that of the terminal 200-2 of another manufacturer B, and thus, the number of handover sessions might be performed through the “across-two-cells” or the “across-three-cells” in a time shorter than the threshold time similarly to the first embodiment. In this second embodiment, in the base station 100, a “manufacturer ID” and a “manufacturer model ID” are added to the logging information so that the change determination of the measurement parameter can be made on the basis of the logging information including them, and the hysteresis value can be adjusted for each manufacturer or each manufacturer model ID. The “manufacturer ID” is an identifier that identifies a company (or a manufacturer) that manufactures or sells the terminal 200, and the “manufacturer model ID” is an identifier that identifies the model of the terminal 200, for example.

A configuration example of each of the radio communication system 10, the networks 510 and 520 is the same as in the first embodiment (FIGS. 1 and 2, for example). Also, the relation between the cell and the base station 100 is the same as in the first embodiment (FIGS. 3A to 5B). Moreover, the entire configuration of the base station 100 (FIG. 6, for example) and each configuration example of the terminal 200 (FIGS. 8 and 9, for example) are the same as in the first embodiment.

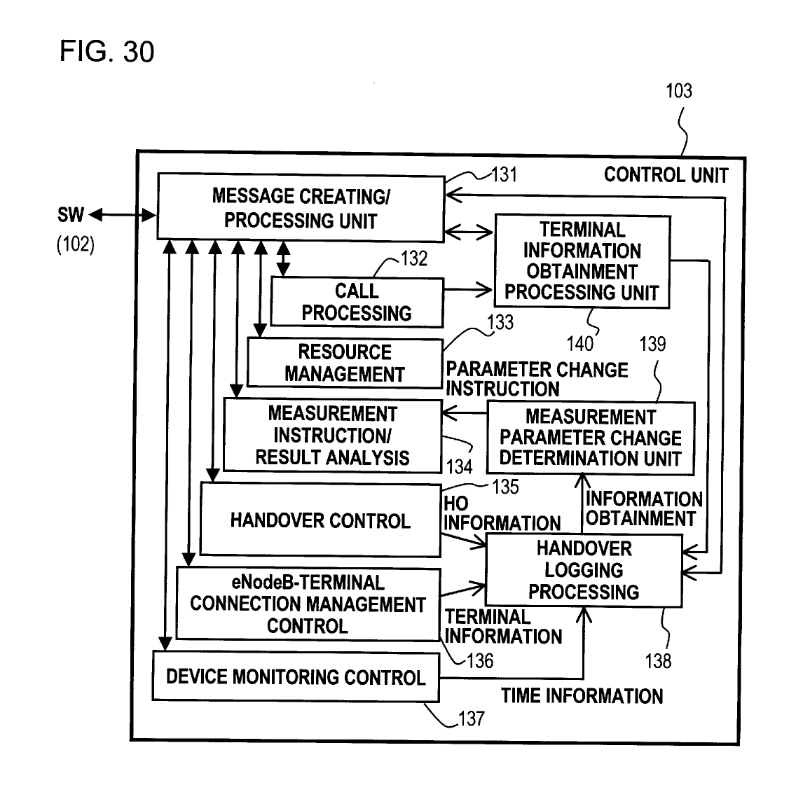

FIG. 30 is a diagram illustrating a configuration example of the control unit 103 of the base station 100 in the second embodiment. The control unit 103 is further provided with a terminal information obtainment processing unit 140.

The terminal information obtainment processing unit 140, for example, extracts a message including the “manufacturer ID” and the “manufacturer model ID” relating to the terminal 200 from the HSS 420, which is a superior device in the call processing, from the call processing unit 132 and outputs these two types of information to the logging processing unit 138. The logging processing unit 138 holds the logging information including these types of information in the table 1381 and stores the logging information in each field similarly to the first embodiment.

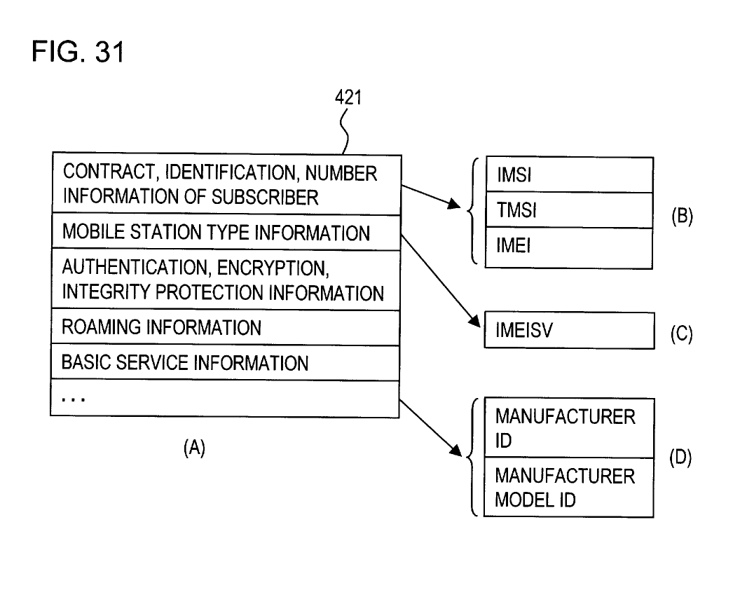

In this second embodiment, the HSS 420 is supposed to hold the “manufacturer ID” and the “manufacturer model ID” in advance prior to the call processing. FIGS. 31A to 31D are diagrams illustrating examples of information held by the HSS 420. The HSS 420 holds an HSS table 421, holds type information such as number information and mobile station (or terminal) for each subscriber in the HSS table 421. The HSS 420 holds IMSI, TMSI, and IMEI as number information, for example, and holds IMEISV (IMEI Software Version) as type information. The IMEISV is the one in which version information is further added to IMEI, for example, and is a number unique to each terminal and to each software version stored in the terminal 200. The base station 100 obtains the “manufacturer ID” and the “manufacturer model ID” from the HSS 420 in the call processing, for example.

FIGS. 31 is a sequence diagram illustrating an example of the call processing. First, the processing to establish a call and the like is executed between the terminal 200 and the MME 410 via the base station 100 (S120).

Then, the MME 420 issues the TMSI to the terminal 200 and inquires about the IMEISV held in the terminal 200 from the terminal 200 (S121, S122). The base station 100 process or create a command (“Security Mode Command”) or a message and the like used for this processing between the call processing unit 132 and the message creating unit 131 through this inquiry. The terminal 200 may hold this TMSI as a terminal identifier and transmit the TMSI included in the message when it transmits the Measurement Report message (S12 and the like).

Then, the terminal 200 and the like respond IMEISV to the command from the base station 100 and the like (S123, S124). For example, the terminal 200 responds in a pair of TMSI and IMEISV. For example, the terminal 200 and the like respond with the “Security Mode Complete” included in this pair. For example, the call processing unit 232 of the terminal 200 holds IMEISV in advance and instructs the message creating unit 231 to create a response message including IMEISV.

When the MME 410 receives the response, it associates the TMSI and IMEISV with each other (S125). For example, the MME 410 holds a table in which TMSI and IMEISV are made a pair in the memory and stores information of TMSI and IMEISV received by a response in the table.

Then, the MME 410 transmits a message including IMEISV (“UE Information Request”, for example) to the HSS 420 in order to obtain the “manufacturer ID” and the “manufacturer model ID” (S126).

When the HSS 420 receives the message, it reads the “manufacturer ID” and the “manufacturer model ID” corresponding to the IMEISV from the HSS table 421 and transmits a response message including them (“UE Information Response”, for example) (S127).

When the MME 410 receives the response message, it holds the “manufacturer ID” and the “manufacturer model ID” in a table paired with TMSI and the like, for example.

On the other hand, the base station 100 transmits the message including the TMSI (“UE Information Request”, for example) to MME 410 in order to obtain the “manufacturer ID” and the “manufacturer model ID” from the MME 410 (S128).

When the MME 410 receives the message, it transmits the “manufacturer ID” and the “manufacturer model ID” corresponding to the TMSI to the base station 100 (S129). The base station 100 may hold the TMSI in the table 1381 through the processing at S121 or S123 or the like, for example. For example, when the connection management control unit 136 inputs the message received at S121 or S132 and the like from the message creating unit 131 and outputs it to the logging processing unit 138, the message and the like are held in the table 1381.

As a result, the base station 100 holds the “manufacturer ID” and the “manufacturer model ID” for each terminal identifier (TMSI, for example) and can execute each operation (1.1 to 2.3) described in the first embodiment after that (S10 and the like). In each operation, the terminal 200 transmits the terminal identifier of itself (TMSI, for example) included in the Measurement Report, for example (S12 and the like). The base station 100 receives the message and stores the logging information in each field on the basis of the terminal identifier. Since the terminal identifier is specified, the “manufacturer ID” and the “manufacturer model ID” are also specified, and in the above call processing, if the “manufacturer ID” and the like are held for each terminal identifier, each piece of logging information in the table 1381 is stored in accordance with the terminal identifier similar to the above-described 1.1 and the like.

Also, in each operation (1.1 to 2.3), the determination on the change of the hysteresis value (S30) and the notification to the terminal 200 (S31) can be also operated similarly to the first embodiment. Therefore, in this second embodiment, too, the number of handover sessions of the terminal 200 is reduced, and reductions of the power consumption of the terminal 200 and the processing of the base station 100 can be realized. Also, since the hysteresis value is not adjusted manually, a cost of this system 500 can be reduced. When the terminal identifier is different, the “manufacturer ID” and the “manufacturer model ID” are also different

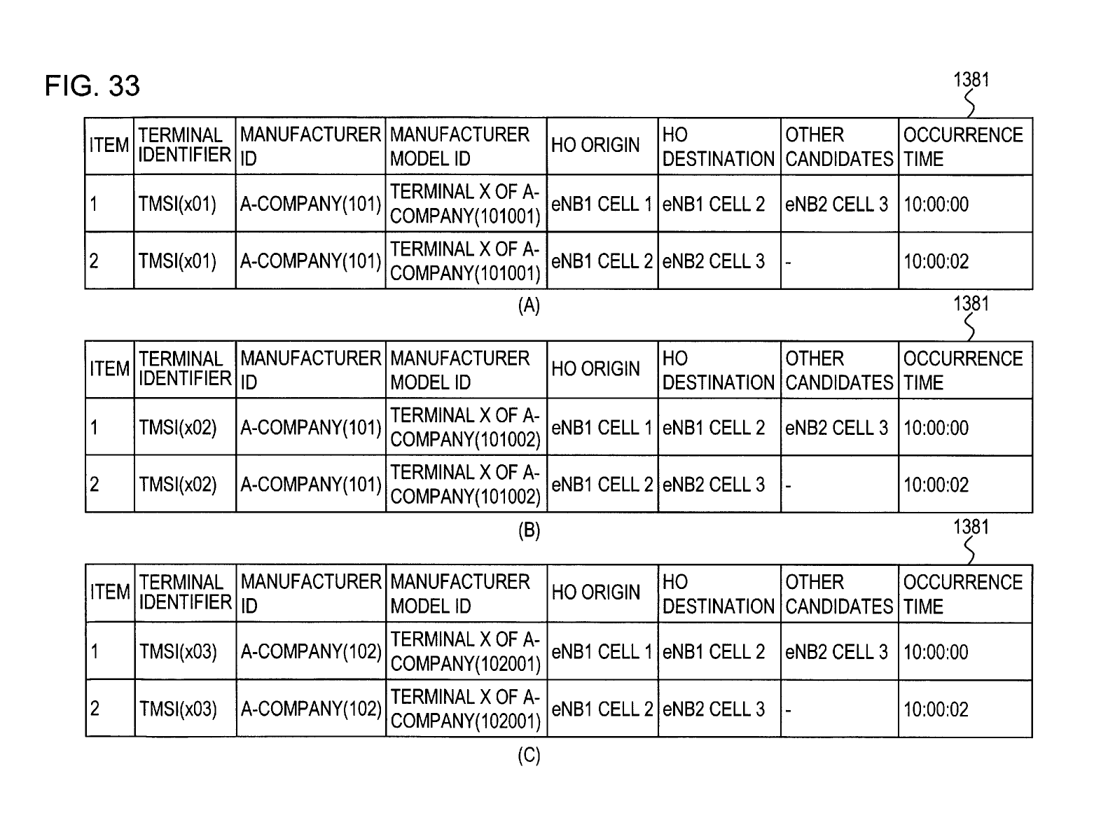

FIGS. 33A to 33C are diagrams illustrating examples of the table 1381 held by the logging processing unit 138 in the base station 100. The table 1381 illustrated in these figures illustrate examples of the logging information when the terminals 200 with different terminal identifiers (“TMSI(x01)” to “TMSI(x03)”) perform handover in the “across-three-cells” manner, for example.

### Other Embodiments

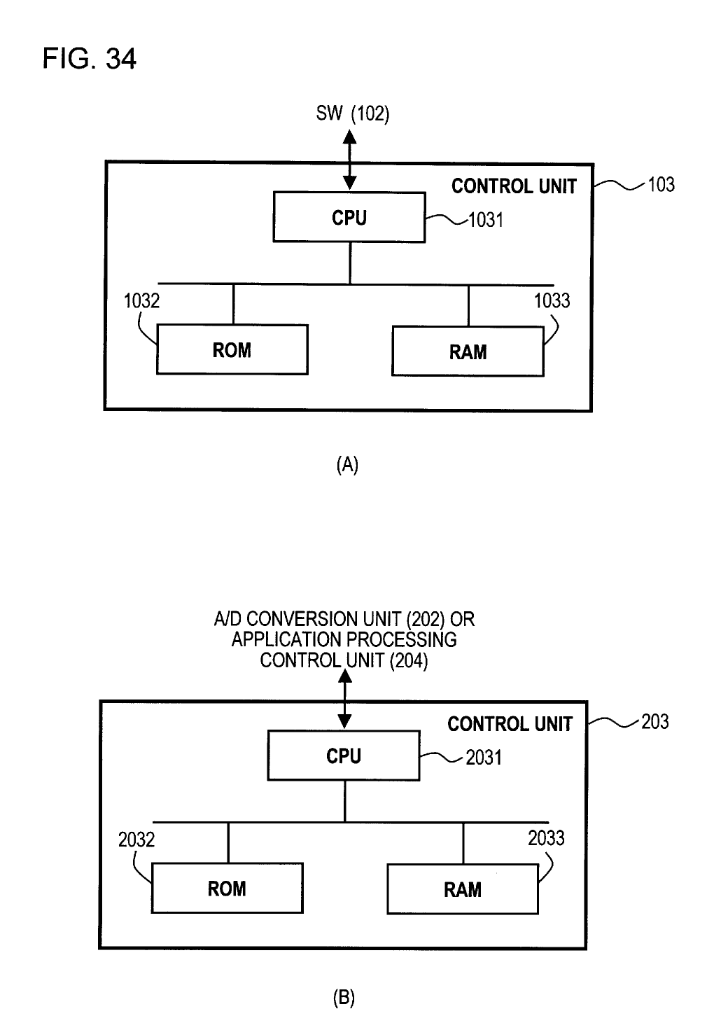

Subsequently, the other embodiments will be described. In each of the above-described first and second embodiments, the inside of the control unit 103 of the base station 100 was described as being configured by hardware. For example, the control unit 103 may be configured by software as illustrated in FIG. 34A. For example, by configuring such that a ROM 1032 holds a program, and a CPU 1031 reads the program from the ROM 1032 and executes the program, the functions of those from the message creating unit 131 to the device monitoring control unit 137 and the change determination unit 139 can be realized. Also, by configuring such that a RAM 1033 holds the table 1381, and the CPU 1031 reads it as appropriate, the function of the logging processing unit 138 can be realized. As a result, the first and second embodiments can be also put into practice by means of the software illustrated in FIG. 34A.

Also, the digital baseband processing control unit 203 of the terminal 200 may also be configured by software as illustrated in FIG. 34B. A CPU 2031 reads a program from a ROM 2032 and executes it so that the functions of those from the message creating unit 231 to the power control unit 238 can be realized. Also, the RAM 2033 plays a role as working memory when the CPU 2031 executes the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio base station apparatus for performing radio communication with a terminal apparatus, comprising:
a logging processing unit which stores history information relating to handover in a storage unit, when the terminal apparatus performs handover;
a change determination unit which determines whether a measurement parameter used by the terminal apparatus for determination of the handover is to be changed or not, on the basis of the history information, and outputs a change instruction if the change determination unit determines that the measurement parameter is to be changed; and
a transmission unit which transmits the measurement parameter changed on the basis of the change instruction to the terminal apparatus.

2. The radio base station apparatus according to claim 1, wherein the logging processing unit stores the history information relating to each handover in the storage unit when the terminal apparatus performs handover from a first cell to the first cell via a second cell, respectively, or the terminal apparatus performs handover from the first cell to a third cell via the second cell, respectively.

3. The radio base station apparatus according to claim 1, wherein the logging processing unit stores, in each time the handover occurs, the history information including an identifier of a cell at a handover source, an identifier of a cell at a handover destination, and occurrence time of the handover.

4. The radio base station apparatus according to claim 1, wherein the change determination unit outputs the change instruction, if a time interval at which the handover is performed within a first threshold time is within a second threshold time and the handover is performed within the first threshold time a threshold value number of times or more on the basis of the history information.

5. The radio base station apparatus according to claim 2, wherein
the radio base station apparatus contains the first and second cells in a case in which the terminal apparatus performs handover from the first cell to the first cell via the second cell, and
the radio base station apparatus contains the first to third cells in a case in which the terminal apparatus performs handover from the first cell to the third cell via the second cell.

6. The radio base station apparatus according to claim 2, wherein the radio base station apparatus contains the first cell, and first radio base station apparatus connected to the radio base station apparatus contains the second cell, in a case in which the terminal apparatus performs handover from the first cell to the first cell via the second cell.

7. The radio base station apparatus according to claim 2, wherein the radio base station apparatus contains the first and second cells, and first radio base station apparatus connected to the radio base station apparatus contains the third cell, in a case in which the terminal apparatus performs handover from the first cell to the third cell via the second cell,

8. The radio base station apparatus according to claim 2, wherein the radio base station apparatus contains the first cell, and first radio base station apparatus connected to the radio base station apparatus contains the second and third cells, in a case in which the terminal apparatus performs handover from the first cell to the third cell via the second cell.

9. The radio base station apparatus according to claim 2, wherein the radio base station apparatus contains the first and third cells, and first radio base station apparatus connected to the radio base station apparatus contains the second cell, in a case in which the terminal apparatus performs handover from the first cell to the third cell via the second cell.

10. The radio base station apparatus according to claim 2, wherein the radio base station apparatus contains the first cell, first radio base station apparatus connected to the radio base station apparatus contains the second cell, and second radio base station apparatus connected to the first radio base station apparatus contains the third cell, in a case in which the terminal apparatus performs handover from the first cell to the third cell via the second cell.

11. The radio base station apparatus according to claim 6, further comprising:
a handover control unit which transmits or receives a handover request message when the terminal apparatus performs handover, wherein
the logging processing unit stores in a storage unit time when the handover control unit transmits the handover request message to the first radio base station apparatus or time when the handover control unit receives the handover request message from the first radio base station apparatus as occurrence time of the handover in the history information.

12. The radio base station apparatus according to claim 11, wherein the handover control unit transmits the handover request message including a terminal identifier of the terminal apparatus to the first radio base station apparatus.

13. The radio base station apparatus according to claim 11, wherein the handover control unit transmits to the first radio base station apparatus the handover request message including a manufacturer identifier identifying a manufacturing company that manufactures the terminal apparatus, a model identifier identifying a model of the terminal apparatus, and a terminal identifier.

14. The radio base station apparatus according to claim 12, wherein the terminal identifier is TMSI.

15. The radio base station apparatus according to claim 8, wherein the logging processing unit receives the history information stored in the first radio base station apparatus from the first radio base station apparatus, and stores the history information in the storage unit, when the terminal apparatus performs handover from the second cell to the third cell.

16. The radio base station apparatus according to claim 1, wherein the measurement parameter is added to a communication quality for the radio base station apparatus containing a cell of connection destination and is used for determination of handover in the terminal apparatus.

17. The radio base station apparatus according to claim 3, wherein the history information includes a manufacturer identifier identifying a manufacturing company that manufactures the terminal apparatus and a model identifier identifying a model of the terminal apparatus.

18. A radio communication method in a radio base station apparatus for performing radio communication with a terminal apparatus, comprising:
storing history information to the handover in a storage unit when the terminal apparatus performs handover;
determining whether a measurement parameter used by the terminal apparatus for determination of the handover is to be changed or not, on the basis of the history information, and outputting a change instruction if it is determined that the measurement parameter is to be changed; and
transmitting the measurement parameter changed on the basis of the change instruction to the terminal apparatus.

19. A computer-readable non-transitory medium storing a program executed by a computer that controls a radio base station apparatus performing radio communication with a terminal apparatus, comprising:
storing history information to the handover in a storage unit when the terminal apparatus performs handover;
determining whether a measurement parameter used by the terminal apparatus for determination of the handover is to be changed or not, on the basis of the history information and outputting a change instruction if it is determined that the measurement parameter is to be changed; and
transmitting the measurement parameter changed on the basis of the change instruction to the terminal apparatus.
